(19) United States
(12) Patent Application Publication
(10) Pub. No.: US 2022/0410243 A1
(43) Pub. Date: Dec. 29, 2022

(54) APPARATUS FOR PRODUCING HOLLOW PANELS AND METHOD OF OPERATING SAME

(71) Applicant: AIL INTERNATIONAL INC., Sackville (CA)

(72) Inventors: Michael W. WILSON, Sackville (CA); Wayne W. FORD, Moncton (CA)

(21) Appl. No.: 17/853,553

(22) Filed: Jun. 29, 2022

Related U.S. Application Data
(60) Provisional application No. 63/216,361, filed on Jun. 29, 2021.

(51) Int. Cl. B21D 28/04; B21D 28/34; B21D 28/14; B21D 28/28

(52) U.S. Cl. CPC B21D 28/04; B21D 28/34; B21D 28/14; B21D 28/28

(57) ABSTRACT

A system for punching slots in a hollow elongate panel. The system includes: a die matrix configured to be receivable within the hollow elongate panel, the die matrix including at least one locating aperture and at least one matrix void. The system includes a punching apparatus including at least one punch configured to be extended through corresponding matrix voids of the die matrix to punch one or more slots at the wall of the hollow panel. The system includes a sensing apparatus including at least one sensing pin configured to be extended towards the at least one locating aperture of the die matrix. The punching apparatus may be configured to punch the one or more slots at a downstream wall portion the hollow elongate panel in response to the sensing apparatus determining that the at least one sensing pin is received within a corresponding locating aperture of the die matrix.

### CROSS REFERENCE TO RELATED APPLICATIONS

This application claims priority from U.S. provisional patent application No. 63/216,361, entitled “APPARATUS FOR PRODUCING HOLLOW PANELS AND METHOD OF OPERATING SAME”, filed on Jun. 29, 2021, the entire contents of which are hereby incorporated by reference herein.

### FIELD

The present disclosure generally relates to hollow panels, and in particular to systems and methods for producing hollow panels.

### BACKGROUND

One or more elongate panels may be assembled to provide a barrier, such as a wall or a fence, among other examples. In some scenarios, barriers may be constructed to sub-divide property or to act as a barrier to acoustic waves (e.g., sound walls). In some examples, such barriers may be constructed from a plurality of interconnected panels. The respective interconnected panels may be hollow panels to reduce overall barrier weight or to allow positioning of ancillary devices or materials within the hollow panels.

### SUMMARY

Slots formed on a wall of an elongate panel may be produced based on routing operations. For example, apparatus may include one or more router bits for cutting slots into walls of hollow elongate panels. Router bits may be consumable components and may require periodic replacement, thereby leading to periodic manufacturing system downtime, reduced manufacturing efficiency, or increased costs. It may be beneficial to provide systems and methods of producing slots in hollow elongate panels based on a combination of methods for producing slots in hollow elongate panels.

The present disclosure provides systems and methods for producing hollow elongate panels, including producing slots within walls of hollow elongate panels. In some embodiments, a die matrix may be received within a hollow elongate panel. The die matrix may provide support to walls of the hollow elongate panel during panel routing or panel punching operations.

In some embodiments, systems may include a punching apparatus having punches for punching slots in the hollow elongate panel. The punching apparatus may advance punches towards the hollow elongate panel wall and through corresponding matrix voids for producing slots based on shearing forces at the hollow elongate panel wall. While the present disclosure describes punching apparatus as having punches, in some scenarios, such punches may also be known as punching pins.

In some scenarios, punches and corresponding matrix voids may be misaligned or otherwise offset. When punches are advanced towards a corresponding matrix void that may be misaligned or offset from one another, the punches may be thrust at least in part against a non-void portion of the die matrix thereby resulting in potential damage to the punches or the die matrix. In some scenarios, an offset or misalignment between the punches and the matrix voids by as much as a few thousandths of an inch may contribute to the above-described potential damage. It may be desirable to provide apparatus for validating positional alignment of the punches relative to matrix voids in the die matrix prior to commencing punching operations.

In some embodiments, an alignment sensing apparatus includes features for validating positional alignment of punches with corresponding matrix voids of the die matrix in a panel punching stage prior to commencing punching operations. In scenarios where the punches may be misaligned with corresponding matrix voids by a quantity that may be corrected, the alignment sensing apparatus may include features for refining positional alignment of punches with corresponding matrix voids prior to commencing punching operations.

In scenarios where the punches may be misaligned with corresponding matrix voids by a quantity that may be beyond a threshold (e.g., “correctable”) value, the alignment sensing apparatus may be configured to transmit a signal for temporarily halting punching operations at the panel punching stage to prevent physical damage to punches or the die matrix. Other features of systems and methods for producing hollow elongate panels including slots within the panel walls are described in the present disclosure.

In an aspect, the present disclosure describes a method of punching slots in a hollow elongate panel. The method may include: conveying the hollow elongate panel along a die matrix to expose, via a clearance slot, at least one locating aperture of the die matrix to at least one sensing pin of a sensing apparatus, the die matrix received within the hollow elongate panel, the die matrix including at least one die matrix void and the at least one locating aperture; extending the at least one sensing pin towards the at least one locating aperture of the die matrix; and in response to determining that the at least one sensing pin is received within a corresponding locating aperture of the die matrix, extending at least one punch of a punching apparatus towards a downstream wall portion of the hollow elongate panel and through corresponding matrix voids of the die matrix to punch slots in the hollow elongate panel.

In another aspect, the present disclosure describes a system for punching slots in a hollow elongate panel. The system may include: a die matrix configured to be receivable within the hollow elongate panel, the die matrix including at least one locating aperture and at least one matrix void; a punching apparatus including at least one punch configured to be extended through corresponding matrix voids of the die matrix to punch one or more slots at the wall of the hollow panel; and a sensing apparatus including at least one sensing pin configured to be extended towards the at least one locating aperture of the die matrix, wherein the punching apparatus is configured to punch the one or more slots at a downstream wall portion the hollow elongate panel in response to the sensing apparatus determining that the at least one sensing pin is received within a corresponding locating aperture of the die matrix.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the present disclosure.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 illustrates a partially exploded, perspective view of a sound wall, in accordance with an embodiment of the present disclosure;

FIGS. 2A and 2B illustrate partial perspective views of elongate panels, in accordance with embodiments of the present disclosure;

FIGS. 3A and 3B illustrate partial perspective views of elongate panels, in accordance with embodiments of the present disclosure;

FIG. 4 illustrates a system for producing elongate panels, in accordance with embodiments of the present disclosure;

FIG. 5 illustrates a partial front perspective view of the system of FIG. 4;

FIG. 6 illustrates an enlarged view of the panel receipt stage illustrated in FIG. 5;

FIG. 7 illustrates a perspective view of a die matrix, in accordance with embodiments of the present disclosure;

FIGS. 8A and 8B illustrate a perspective view and a side view, respectively, of components of a punching apparatus, in accordance with embodiments of the present disclosure;

FIG. 9 illustrates an enlarged, partial view of the system of FIG. 4;

FIG. 10 illustrates a partial, rear perspective view of the panel routing stage of FIG. 4;

FIG. 11 illustrates a partial, perspective view of a routing apparatus, in accordance with embodiments of the present disclosure;

FIG. 12 illustrates an enlarged cross-sectional view of the panel routing stage, the panel punching stage, and the alignment sensing stage of FIG. 4;

FIG. 13 illustrates an enlarged, cross-sectional view of the alignment sensing stage of FIG. 4;

FIG. 14 illustrates a rear perspective view of the alignment sensing stage shown in FIG. 13;

FIG. 15 illustrates an enlarged, cross-sectional view of the alignment sensing stage of FIG. 4;

FIG. 16 illustrates a rear perspective view of the alignment sensing stage illustrated in FIG. 15;

FIG. 17 illustrates an enlarged, rear perspective view of the panel routing stage, the panel punching stage, and the alignment sensing stage of FIG. 4;

FIG. 18 illustrates a cross-sectional, perspective view of the cutout evacuation stage of the system illustrated in FIG. 4;

FIG. 19 illustrates a partial exploded view of an alignment sensing stage, in accordance with embodiments of the present disclosure; and

FIG. 20 illustrates a partial perspective view of a punching apparatus, in accordance with another embodiment of the present disclosure.

### DETAILED DESCRIPTION

The present disclosure describes systems and methods for producing hollow elongate panels. In some embodiments, systems and methods for producing hollow elongate panels may include apparatus for producing slots within walls of the hollow elongate panels.

A punching apparatus may include a die matrix receivable within hollow elongate panels conveyed along the system. The die matrix may provide support to walls of the hollow elongate panel during panel routing or punch operations. In some embodiments, systems may include a punching apparatus having punches for punching slots in the hollow elongate panel. The punching apparatus may advance punches toward the hollow elongate panel wall and through corresponding matrix voids of the die matrix. Slots in the hollow elongate panel may be produced based on shearing forces at the hollow elongate panel wall.

In scenarios where the punches and corresponding matrix voids are misaligned or otherwise offset, advancing the punches towards a corresponding matrix void may result in the punches being thrust at least in part against a non-void portion of the die matrix, thereby resulting in damage to one or more punches or the die matrix. It may be desirable to provide systems and methods for validating positional alignment of the punches relative to the matrix voids in the die matrix prior to commencing punching operations.

In some scenarios, it may be desirable to provide systems and methods for imparting positional adjustments of the die matrix relative to punches for obtaining substantial alignment of the punches relative to a corresponding matrix void. In some embodiments, positional adjustments may be made to the die matrix for aligning the punches relative to a corresponding matrix void.

In some other embodiments, positional adjustments may be made to the punches, or to features of the punching apparatus, for aligning the punches relative to a corresponding matrix void.

Features of systems and methods for producing such hollow elongate panels including slots will be described in the present disclosure.

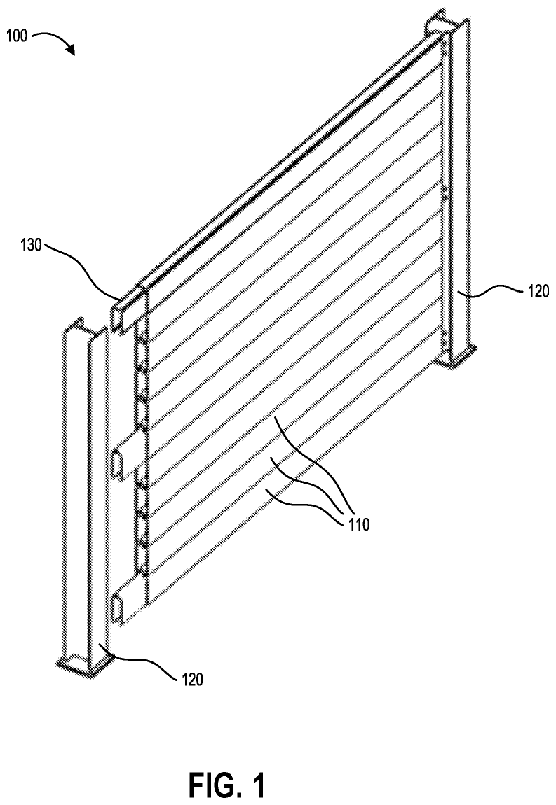

Reference is made to FIG. 1, which illustrates a partially exploded, perspective view of a sound wall 100, in accordance with an embodiment of the present disclosure. The sound wall 100 may include laterally spaced support posts 120 extending from an underlying earth formation. The sound wall 100 may include a plurality of elongate panels 110 stacked atop one another. The plurality of elongate panels 110 may extend between the laterally spaced posts 120.

In some embodiments, the respective elongate panels 110 may be hollow panels or tubular panels. In some embodiments, the elongate panels 110 may be constructed from plastic material, such as polyvinylchloride (PVC), among other examples. Other materials for forming the elongate panels 110 may be contemplated.

In some embodiments, elongate plastic panels may be produced by extrusion process operations. In some embodiments, metallic panels may be produced by processes for bending metal into required structures. In some embodiments, elongate panels may be produced by pre-casting concrete or fabricating wood structures. Other operations for producing elongate panels 110 may be used.

For ease of exposition, FIG. 1 illustrates a pair of laterally spaced support posts 120 having a plurality of elongate panels 110 extending there between. In some scenarios, the sound wall 100 may span a greater distance and may include a series of laterally spaced support posts 120, and sets of stacked elongate panels 110 may extend between pairs of adjacent support posts 120.

In some embodiments, the respective support posts 120 may be elongate beam members in the form of an H-beam or an I-beam. The support posts 120 may be constructed from steel or other suitable structural material. In some embodiments, the support posts 120 may be configured as an H-beam or I-beam having flanges substantially perpendicular to a central member. In some examples, the plurality of elongate panels 110 may be received between flanges of the H-beams or I-beams, thereby being secured between a pair of adjacent support posts 120. Other configurations of support posts 120 for securing elongate panels 110 may be contemplated.

In some embodiments, the sound wall 100 may include an elongate stiffener member 130 positioned within one or more of the plurality of elongate panels 110. In the drawing of FIG. 1, the elongate stiffener member 130 may be positioned within a top elongate panel, a bottom elongate panel, and one or more intermediate elongate panels in the plurality of elongate panels 110. In some scenarios, positioning the elongate stiffener member 130 within the one or more elongate panels 110 may structurally enhance the respective elongate panels 110 by reducing deflection of the respective or the combined stack of elongate panels 110.

In some embodiments, one or more of the elongate panels 110 may include other materials positioned therein, such as acoustic or sound dampening materials, to fill the hollow core of the respective elongate panels 110. As will be disclosed herein, when elongate panels 110 are filled with acoustic dampening materials, the elongate panels 110 may include one or more slots or apertures positioned on a panel wall surface. The slots or apertures may allow acoustic waves to permeate the elongate panel surface, and the acoustic waves may be dampened by the dampening material.

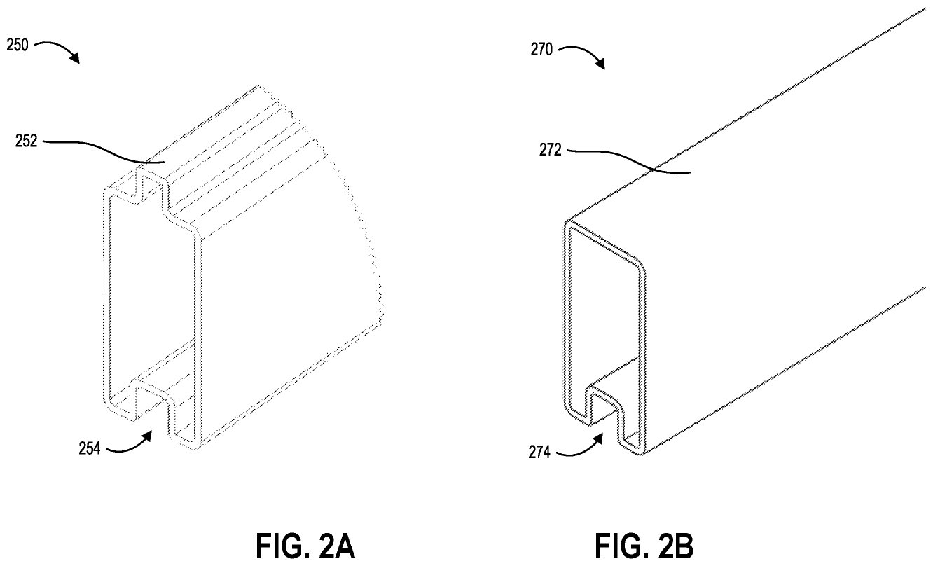

Reference is made to FIGS. 2A and 2B, which illustrate partial perspective views of elongate panels, in accordance with embodiments of the present disclosure. The elongate panels may include mating formations. The mating formations may be configured to fit adjacent or stacked elongate panels together. In some embodiments, the mating formations may be configured to reduce openings or voids between adjacent elongate panels of a sound wall, thereby reducing passage of acoustic waves between adjacent elongate panels.

As an example, FIG. 2A illustrates a partial perspective view of an intermediate elongate panel 250, in accordance with an embodiment of the present disclosure. The intermediate elongate panel 250 may include mating formations, such as tongue formations 252 or groove formations 254 complementary in shape, thereby allowing adjacent elongate panels to fit together (e.g., align or interlock). The mating formations may be configured to minimize openings between adjacent elongate panels 250.

FIG. 2B illustrates a partial perspective view of an end elongate panel 270, in accordance with an embodiment of the present disclosure. The end elongate panel 270 may be placed at an end of a series of stacked elongate panels, and may include a substantially planar top wall 272. In some embodiments, the bottom wall may be configured, along a central region, to define an upstanding groove formation 274 extending substantially the length of the elongate panel. The upstanding groove formation 274 may receive a tongue formation 252 (FIG. 2A) of an adjacent intermediate elongate panel 250 (FIG. 2A).

Embodiments described herein may describe features by indicating direction or position (e.g., bottom wall, front wall, rear wall, top wall, lower wall, or the like). The direction or relative position of the respective wall may not be a requirement of the one or more features. For example, references to top wall, bottom wall, front wall, rear wall, or the like are for convenience, and in some embodiments the direction or relative position of the wall shall not be limiting.

For example, an embodiment of the intermediate elongate panel may include a first end wall including an upstanding tongue. The intermediate elongate panel may include a first side wall and a second side wall extending from opposing sides of the first end wall. Further, the intermediate elongate panel may include a second end wall having a groove formation formed by a pair of inner walls and extending a length of the hollow elongate panel. The groove formation may extend into the hollow elongate panel. However, other terminology may be used for describing direction or relative position of features of the elongate panel.

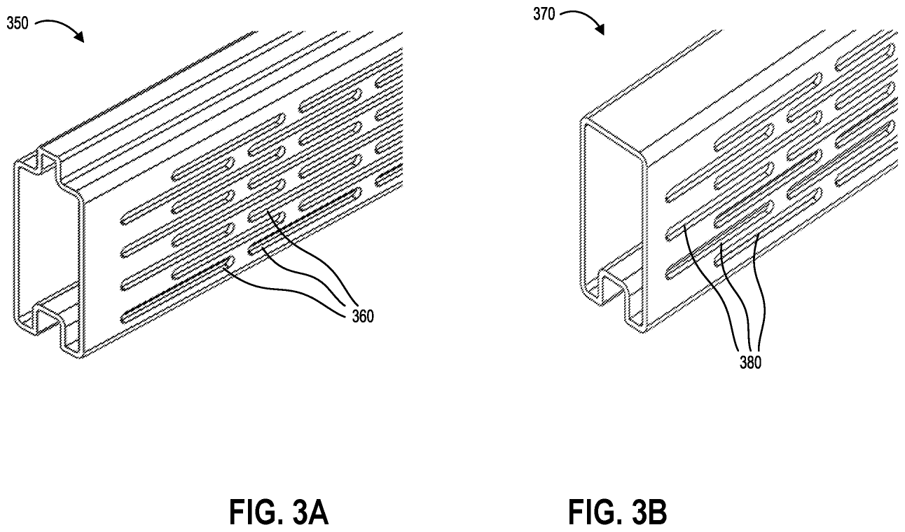

In some embodiments, one or more elongate panels of a sound wall may be configured to reduce incident acoustic waves from: (a) being transmitted through the sound wall or (b) being reflected from the sound wall surface. The sound wall may be configured to dampen acoustic waves based at least, in part, on presence of an absorptive member. To illustrate, reference is made to FIGS. 3A and 3B, which illustrate partial perspective views of elongate panels, in accordance with embodiments of the present disclosure.

FIG. 3A illustrates an example elongate panel 350 similar to the intermediate elongate panel 250 of FIG. 2A, and further includes one or more slots 360 formed in a rear wall or a front wall of the elongate panel 350. Acoustic mineral wool or other absorptive material may be positioned within the elongate panel 350 to occupy the hollow core of the elongate panel 350.

FIG. 3B illustrates an example elongate panel 370 similar to the elongate panel 270 illustrated in FIG. 2B, and further includes one or more slots 380 formed in a rear wall or a front wall of the elongate panel 370. In some embodiments, acoustic mineral wool or other absorptive material may be positioned within the elongate panel 370. As acoustic waves may be incident on either a front wall or a rear wall of the elongate panel 370, the absorptive material may reduce the quantity of acoustic waves that is incident on and reflected from the front wall or the rear wall.

Embodiments of systems and methods for producing one or more slots on a surface of hollow elongate panels are described in the present disclosure. In some scenarios, the one or more slots or apertures may be produced based on one of laser cutting operations, plasma cutting operations, milling operations, punching operations, or water jet cutting operations (e.g., utilizing high pressure liquid streams to cut through materials), among other examples.

When slots or apertures are produced by laser etching operations, specialized laser etching apparatus may be required. Specialized laser etching apparatus may include operations based on melting portions of the surface of the work piece (e.g., wall of an elongate panel) at targeted or specific locations. Such specialized equipment may be costly and require a specifically controlled operative environment. In some scenarios, laser etching apparatus may not be configurable to control the depth of cuts into a work piece, thereby requiring additional processes for controlling depth of cuts. For example, added operations for inserting blocking material may be required for reducing likelihood of cuts being deeper than expected.

In some embodiments, slots or apertures may be formed on a wall of an elongate panel based predominately or solely on routing operations. For example, an apparatus having milling or routing bits may cut the wall of the elongate panel for producing the slots or apertures. Milling or router bits may be consumable components requiring periodic replacement, leading to periodic manufacturing system downtime and reduced manufacturing efficiency. Replacement of milling or router bits may represent substantial system operating costs over time. It may be desirable to provide systems and methods of forming slots within elongate hollow panels with reduced system operating costs.

In some embodiments, slots or apertures may be formed on a wall of an elongate panel based on punching operations. Punching operations may be conducted using precision tools, and punching operations may include cutting portions of a hollow panel to form the slots or apertures. A die matrix having voids thereon may be positioned within a hollow elongate panel (e.g., the hollow work piece). Punches may be pressed through a wall of the hollow elongate panel and through a corresponding die matrix void for producing a slot in the wall of the hollow elongate panel. The punch may impart shear forces at the wall of the hollow elongate panel for producing the slot in the wall of the hollow elongate panel.

To produce slots within the hollow elongate panel, the above described example punching apparatus may include punches that need to be precisely calibrated or aligned with corresponding die matrix voids. In scenarios where the punches may not be precisely positioned to be aligned with openings of the die matrix voids, the punches may be thrust incident, at least partly, on a solid portion of the die matrix thereby damaging the punches or the die matrix (e.g., self-destructing operations). It may be desirable to provide features of systems and methods for producing slots in hollow elongate structures to reduce occurrences of self-destructing operations.

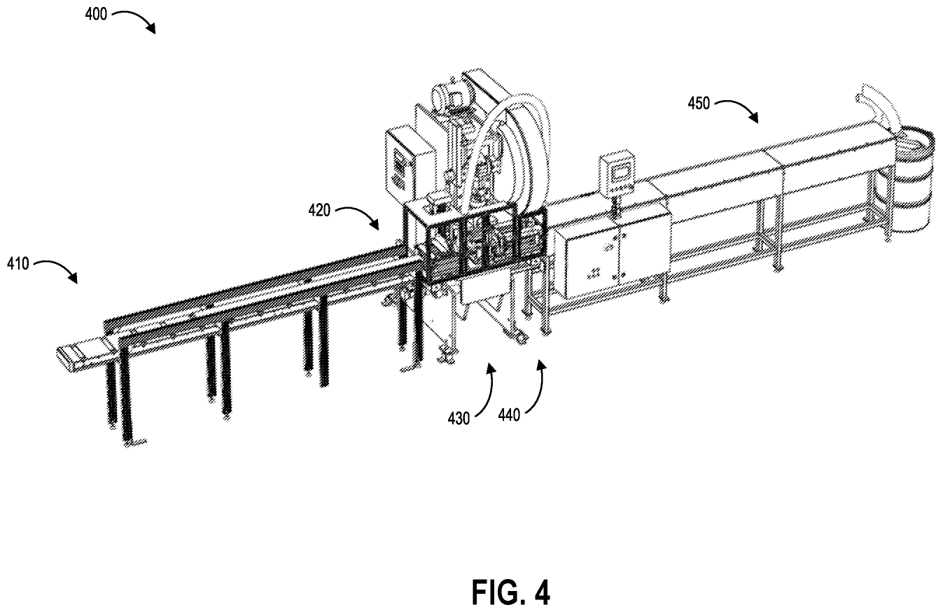

Reference is made to FIG. 4, which illustrates a system 400 for producing elongate panels, in accordance with embodiments of the present disclosure. In some embodiments, the elongate panels may be hollow elongate panels. The system 400 may include a combination of a plurality of stages for producing the hollow elongate panels.

The system 400 may conduct operations on a work piece, such as a hollow elongate panel. In some embodiments, hollow elongate panels may be produced by an extrusion process. In some embodiments, the hollow elongate panels may be metallic panels produced by bending processes. In some embodiments, the hollow elongate panels may be produced by pre-casting operations. Other operations for producing elongate panels may be used. The system 400 may conduct operations on hollow work pieces having other configurations.

The system 400 may conduct operations to generate an array of slots along the surface of the hollow elongate structure. The system 400 may conduct operations at a plurality of stages. The system 400 may include a panel receipt stage 410, a panel routing stage 420, a panel punching stage 430, an alignment sensing stage 440, or a cutout evacuation stage 450. Embodiments of the respective stages are illustrated in FIG. 4 in an example physical sequence.

As will be described in the present disclosure, for producing one or more slots in the hollow elongate panel, the system 400 may conduct operations of the respective operational stages in a sequence that may be different than the physical sequence of operational stages illustrated in FIG. 4. For example, the system 400 may conduct routing operations, followed by alignment sensing operations, which may subsequently trigger punching operations.

As an example, prior to conducting punching operations (operation 430) for producing slots in a hollow elongate panel, the alignment sensing stage 440 may conduct operations for advancing a sensing pin through a clearance slot and towards a locating aperture in a die matrix for: (i) validating positional alignment of the punches with matrix voids in the die matrix; and/or (ii) refining positional alignment of punches with corresponding matrix voids in the die matrix. In some embodiments, the alignment sensing stage 440 may be configured to transmit a punch command for the panel punching stage 430 for triggering advancement of at least one punch through the at least one matrix void of the die matrix.

In some embodiments, the alignment sensing stage 440 may conduct operations including advancing a sensing pin through a clearance slot in the hollow elongate panel and towards at least one locating aperture of the die matrix. The clearance slot may have been produced by prior-routing operations at the panel routing stage 420.

When the hollow elongate panel having the clearance slot is conveyed to the alignment sensing stage 440, the clearance slots may be configured to expose at least one locating aperture of the die matrix, thereby allowing the sensing pin to be advanced through the clearance slot. The alignment sensing stage 440 may include operations for verifying that the at least one sensing pin is received by the at least one locating aperture, and may subsequently trigger advancement of at least one punch towards a matrix void for producing a slot in the hollow elongate panel.

Accordingly, the alignment sensing stage 440 may be configured to confirm positional alignment of the die matrix relative to the punches, such that subsequent punching operations (at the panel punching stage 430) are halted when misalignment of the die matrix relative to the punches is detected. Such combination of operations may reduce occurrences of misalignment of system components as the work piece is conveyed through the system 400, thereby reducing occurrences of damaging or otherwise self-destructing operations to the system 400.

The panel receipt stage 410 may be an entry point to the system 400 for a work piece. In some embodiments, the work piece may be a hollow elongate panel such as a sound wall panel. The panel receipt stage 410 may include a conveyance apparatus for conveying the hollow elongate panel towards or through subsequent stages.

In some embodiments, the panel receipt stage 410 may include structures for positioning the hollow elongate panel. For example, the structures may include structures for validating that the hollow elongate structures are of a specified dimension. In scenarios where the hollow elongate structures may be wider or larger than a specified size, the structures of the panel receipt stage 410 may not permit conveyance of the hollow elongate structure through the panel receipt stage 410.

As the panel receipt stage 410 conveys the hollow elongate panel into the system 400, the conveyance apparatus may slide the hollow panel around a die matrix. In some embodiments, when the conveyance apparatus slides the hollow panel around the die matrix, the die matrix may substantially occupy an interior cavity of the hollow panel. The die matrix may be configured to provide structural support to the hollow elongate panel, such that when punches are lowered towards the hollow elongate panel, the punches produce slots based on shearing forces at the wall of the hollow panel. Other types of forces at the wall of the hollow panel may similarly exist for punching slots in the hollow panel. Operations of a punching apparatus will be described in the present disclosure.

In some embodiments, it may be desirable to detect positional misalignment of components of the system 400 prior to initiating punching operations for producing slots in hollow elongate panels. For example, the system 400 may be configured to detect misalignment of a die matrix relative to die shoes/punches of a punching apparatus. In response to detecting such misalignment, the system 400 may trigger temporary halting of punching operations to prevent damage to components of the system 400.

The panel routing stage 420 may include operations for routing a first or preliminary set of slots in the hollow elongate panel. The first set of slots in the hollow elongate panel may be the first of a series of slots along the hollow elongate panel. As will be described herein, the first set of slots in the hollow elongate panel may be one or more clearance slots through which a sensing pin of an alignment sensing apparatus may be advanced through, and the sensing pin may be advanced towards one or more locating aperture in the die matrix.

The panel routing stage 420 may include routing bits that may be advanced towards the hollow elongate panel for cutting the first set of slots in the hollow elongate panel.

In some embodiments, the panel routing stage 420 may include operations of a computer numerical control (CNC) router or milling machine, which may be a computer-controlled cutting machine. CNC routers may be configured to cut slots in the hollow elongate panel with programmable accuracy and repeatability. In some scenarios, the CNC routers may include router bits. Router bits may be consumable components requiring replacement on a periodic basis. Operations for replacing router bits may lead to periodic system 400 downtime or increased maintenance time as compared to other operations for producing slots. To address one or more challenges disclosed herein, in some embodiments, the system 400 may include operations for combining the accuracy and repeatable properties of an CNC router apparatus with a punching apparatus for producing slots in hollow elongate panels.

In some embodiments, the panel punching stage 430 may include one or more die shoe components having punches for producing slots in the hollow elongate panel. When a hollow elongate panel is conveyed to be positioned around a die matrix, punches may be lowered towards a wall of the hollow elongate panel for generating slots in the wall of the hollow elongate panel based on shear forces at the wall. In some embodiments, the panel punching stage 430 may conduct operations for producing slots on the hollow elongate panel that are downstream from the initial or first set of slots generated by the panel routing stage 420. Embodiments of the panel punching stage 430 will be described with reference to subsequent drawings.

The alignment sensing stage 440 may include operations for confirming alignment of the die matrix relative to punching components associated with the panel punching stage 430. In some embodiments, the alignment sensing stage 440 may include one or more sensing pins configured to be advanced through at least one clearance slot in the hollow panel. The one or more sensing pins may be advanced towards one or more locating aperture in the die matrix that is received within the hollow elongate panel. In some embodiments, the alignment sensing stage 440 may include one or more sensors configured to verify whether the one or more sensing pins is received within a locating aperture of the die matrix.

In scenarios where the one or more sensing pins are advanced towards and received within corresponding locating apertures of the die matrix, the system 400 may determine that the punches (of the panel punching stage 430) are aligned with corresponding matrix voids in the die matrix.

In scenarios where the one or more sensing pins are not aligned with corresponding locating apertures of the die matrix, the sensing pins may not be received by the corresponding locating apertures, thereby indicating that the punches (of the panel punching stage 430) may not be aligned with corresponding matrix voids in the die matrix. Advancing misaligned punches towards the die matrix may cause the punches to contact a non-aperture portion of the die matrix, thereby causing damage to the punches and/or the die matrix. According, when the above-described scenario is detected, the system 400 may be configured to temporarily halt operations of the panel punching stage 430.

In some embodiments, the one or more sensing pins may include a tapered distal end. In scenarios where the one or more sensing pins may not be substantially aligned with corresponding locating apertures of the die matrix, the tapered distal end of the one or more sensing pins may nonetheless assist with the one or more sensing pins being received within the at least one locating aperture.

As will be described with reference to drawings herein, in scenarios where the sensing pins may not be substantially aligned with corresponding locating apertures of the die matrix, and where the sensing pins may nonetheless be received within the locating apertures, the die matrix may be positionally adjusted when sensing pins are extended towards and received within corresponding locating apertures. In some embodiments, insertion of the sensing pins within locating apertures of the die matrix may cause positional adjustments of the die matrix relative to punches of the punching apparatus. As will be described with reference to drawings of the present disclosure, the die matrix may be positionally adjusted in one or more directions (e.g., an x-axis direction, a y-axis direction, or a combination of the x-axis direction and y-axis direct.).

By adjusting the position of the die matrix relative to a punching apparatus (of the panel punching stage 430) or an alignment sensing apparatus (of the alignment sensing stage 440), an unintended scenario, where a die matrix that may have previously been offset by movement caused by insertion of the hollow elongate panel around the die matrix, may be addressed.

Based on embodiments described in the present disclosure, the system 400 may include a conveyance apparatus for conveying a hollow elongate panel around a die matrix. The die matrix may be in a substantially stationary position relative to a routing apparatus, a punching apparatus, and an alignment sensing apparatus.

The routing apparatus may be configured to route one or more initial slots in the hollow elongate panel. The one or more initial slots may serve as one or more clearance slots configured to provide access by one or more sensing pins of the alignment sensing apparatus to at least one locating aperture of a die matrix.

As the hollow elongate panel is conveyed along the system 400, the hollow elongate panel may successively travel or advance along adjacent to a series of apertures or voids in the die matrix. The respective series of apertures or voids in the die matrix may be configured to be positionally aligned with routing bits of the routing apparatus, punches of the punching apparatus, or sensing pins of the alignment sensing apparatus.

When the clearance slots in the hollow elongate panel reach a position proximal to the alignment sensing apparatus, the alignment sensing apparatus may be configured to advance one or more sensing pins through the one or more clearance slots and towards the at least one locating aperture of the die matrix. By successively advancing the one or more sensing pins for receipt within the at least one locating aperture, the alignment sensing apparatus may conduct operations for determining whether the one or more punches of a punching apparatus (e.g., located at a position upstream relative to the alignment sensing apparatus) are positionally aligned with corresponding matrix voids in the die matrix.

Misalignment of punches and matrix voids of the die matrix by more than thousandths of an inch may contribute to damage to the punching apparatus. To reduce occurrences of self-destructing operations, it may be desirable to periodically verify that the die matrix is positioned at an intended position relative to the punching apparatus so as to reduce occurrences of punches being thrust towards portions of the die matrix that do not correspond to matrix voids. As will be described herein, verifying that the die matrix is positioned at a desired position relative to the punching apparatus may be based on the one or more sensing pins being received by at least one locating aperture in the die matrix.

In some embodiments, the system 400 may include a cutout evacuation stage 450. The cutout evacuation stage 450 may include operations that collect or extract cutout portions originating from the hollow elongate panel being conveyed through the panel punching stage 430. In some scenarios, the cutout portions from the hollow elongate panel may be known as slugs.

In some embodiments, the cutout evacuation stage 450 may include a suction or vacuum apparatus configured to generate turbulence for separating cutout portions from the hollow elongate panel or collecting cutout portions of the elongate panel. The cutout evacuation stage 450 may be configured to generate vacuum suction for excavating cutout portions from the panel punching stage 430. Accordingly, the cutout excavation stage 450 includes operations to reduce piling up of cutout portions proximal to the die shoe and punch components of the panel punching stage 430.

The above-described embodiment of the alignment sensing stage 440 may include one or more sensing pins configured for advancing through one or more clearance slots in hollow panels.

In some other embodiments, alignment sensing stages based on fiducial marker recognition and associated punch position adjustments may be used. Such fiducial recognition and punch position adjustments will be described as an alternate embodiment in the present disclosure.

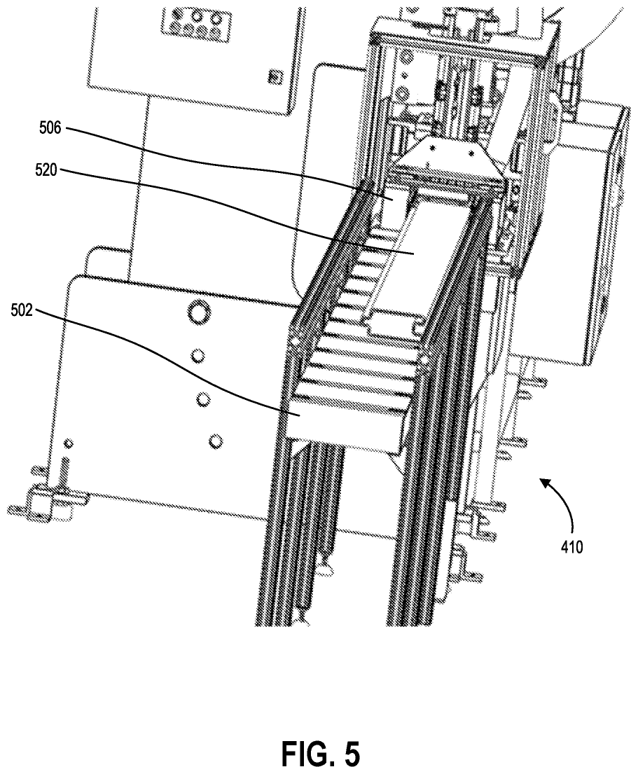

Reference is made to FIG. 5, which illustrates a partial front perspective view of the system 400 of FIG. 4, in accordance with embodiments of the present disclosure. FIG. 5 shows the panel receipt stage 410 (FIG. 4) having a conveyor device for receiving the work piece. In FIG. 5, the illustrated work piece includes a hollow elongate panel 520 or sound wall panel.

The panel receipt stage 410 may include a gateway device 506, which may otherwise be known as a “go—no go” device. The gateway device 506 may be for allowing passage of elongate panels that adhere to design specifications. The gateway device 506 may be configured to allow passage of the hollow elongate panel 520 having a cross-sectional length and width that is substantially equal to or less than a design specification, and to disallow passage of the hollow elongate panel 520 that may be larger than the specified length and width.

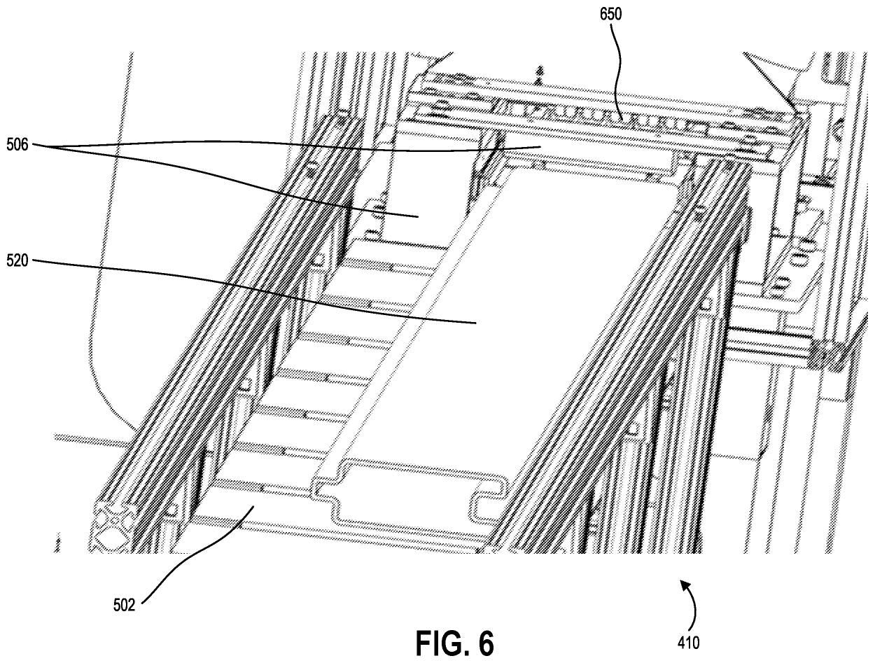

Reference is made to FIG. 6, which illustrates an enlarged view of the panel receipt stage 410 illustrated in FIG. 5. In FIG. 6, one or more router bits 650 of the panel routing stage 420 (FIG. 4) are shown. The panel routing stage 420 may include operations for routing or milling an initial or first set of slots in a wall of the hollow elongate panel. The initial set of slots of the hollow elongate panel may be clearance slots that may: (i) be produced as slots for the hollow elongate panel; and (ii) be configured as clearance slots associated with operations of the subsequent alignment sensing stage 440.

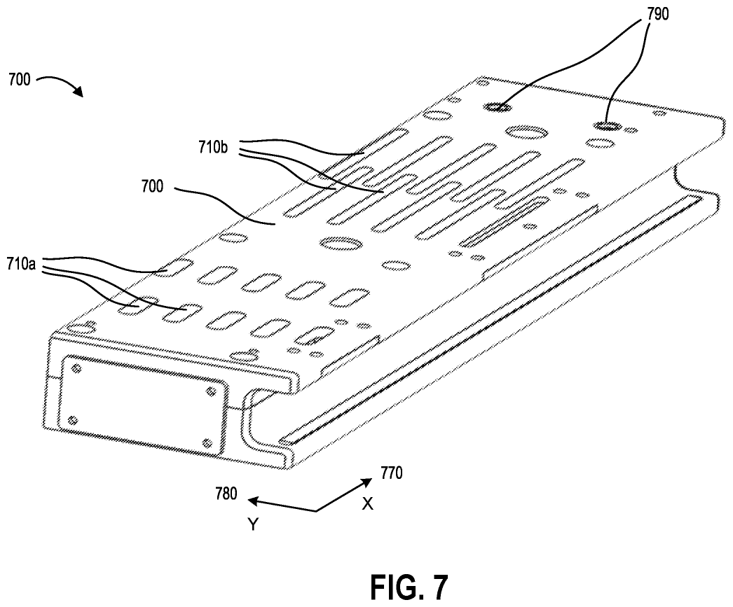

Reference is made to FIG. 7, which illustrates a perspective view of a die matrix 700, in accordance with embodiments of the present disclosure. The die matrix 700 may be configured to be received within a hollow elongate panel (e.g., work piece). In some embodiments, the die matrix 700 may be configured to have a substantially similar shape to the work piece. The die matrix 700 may have a substantially similar shape to a hollow elongate panel, and may be smaller in size such that the die matrix 700 may be received within the hollow elongate panel and may substantially occupy an interior cavity of the hollow elongate panel. The die matrix 700 may provide structural support to one or more walls of the hollow elongate panel.

In some embodiments, the die matrix 700 may be undersized to occupy a volume that is less than the interior cavity volume. The die matrix 700 may in some scenarios be undersized to occupy a volume less than the interior cavity volume to accommodate manufacturing variability in wall thickness of the hollow elongate panel (e.g., hollow work piece).

The die matrix 700 may be an elongate structure and may be positioned to be adjacent the routing apparatus, the punching apparatus, and the alignment sensing apparatus. The die matrix 700 may be coupled to a beam along the system 400 (FIG. 4), such that the die matrix 700 is in a substantially stationary position relative to the routing apparatus, the punching apparatus, and the alignment sensing apparatus.

Although the above-described die matrix 700 may be in a substantially stationary position relative to the above-described apparatus (or stages), the die matrix 700 may be configured to “float” proximal to the above-described apparatus, and may be configured to be positionally adjustable in three-dimensional space. The positional adjustments in three-dimensional space may be associated with relatively small distance adjustments for more accurately aligning punches with matrix voids.

For example, the die matrix 700 may be configured to be adjustable in an x-axis direction 770 (e.g., along a length direction of the hollow elongate panel) or the y-axis direction 780 (e.g., perpendicular to the length direction of the hollow elongate panel). FIG. 7 illustrates an example definition of the x-axis direction and the y-axis direction. As will be described in the present disclosure, when one or more sensing pins are received within locating apertures in the matrix void, receipt of the one or more sensing pins in the locating apertures may cause positional adjustment of the die matrix position, such that die matrix voids are more substantially aligned with punches of a punching apparatus.

In some embodiments, the die matrix 700 may include a plurality of apertures or voids. When the die matrix 700 is positioned along the system 400 (FIG. 4), a first set of die matrix voids 710a may be positioned adjacent the routing apparatus. The first set of die matrix voids 710a may be configured to allow router bits to pass through during routing of the initial set of slots in the wall of the hollow elongate panel.

In some embodiments, the first set of die matrix voids 710a may be configured with a width dimension that may be larger than a diameter of the router bits, such that the router bits may pass through the first set of die matrix voids 710a without touching edges of the respective die matrix voids 710a. The first set of die matrix voids 710a may be known as routing apertures configured to allow passage of one or more router bits during routing of the clearance slots in the hollow elongate panel.

As described based on examples in the present disclosure, routed slots associated with the first set of die matrix voids 710a adjacent the routing apparatus may function as clearance slots for system operations that are downstream of the routing apparatus.

The die matrix 700 may include a second set of die matrix voids 710b. When the die matrix 700 is positioned along the system 400, the second set of die matrix voids 710b may be positioned adjacent the punching apparatus. Respective die matrix voids 710b may be associated with a punch of the punching apparatus, such that when the respective punch is advanced towards the hollow elongate panel, the punch may be thrust through the die matrix voids for producing a hollow elongate panel slot by shearing force at the wall of the hollow elongate panel.

To more efficiently punch slots based on shear forces imparted by the punches to cut slots in walls of the hollow elongate panel, alignment of the punches and matrix voids 710b having small tolerances (e.g., on the order of a thousandths of an inch of tolerance) may be desirable. Because the die matrix 700 may be positionally adjustable in three-dimensional space at a substantially stationary position relative to the punching apparatus, it may be desirable to conduct operations for verifying that punches are substantially aligned with the second set of die matrix voids 710b prior to triggering punching operations. In some embodiments, operations for verifying that the punches are substantially aligned with the second set of die matrix voids 710b may include verification with accuracy to within a thousandths of an inch of dimensional tolerance.

The die matrix 700 may include at least one locating aperture 790. When the die matrix 700 is positioned along the system 400, the at least one locating aperture 790 may be positioned adjacent the alignment sensing apparatus. When the hollow elongate panel having prior-routed slots is conveyed or advanced along the die matrix 700, and when the prior-routed slots in the hollow elongate panel are adjacent the at least one locating aperture 790, the prior-routed slots may function as clearance slots for allowing a sensing pin to be advanced through the clearance slot and towards the at least one locating aperture 790.

In some embodiments, it may be desirable for the die matrix 700 to include two or more locating apertures 790, such that downstream operations including advancing sensing pins into the two or more location apertures 790 for aligning the die matrix voids with punches may be conducted with greater accuracy.

When the sensing pin of the alignment sensing apparatus (described with reference to subsequent figures in the present disclosure) is received by the at least one locating aperture 790, the alignment sensing apparatus may: (i) validate positional alignment of the punches with the second set of matrix voids 710b; and/or (ii) cause, via the sensing pin being received within the at least one locating aperture 790, positional adjustments of the die matrix 700 in two or three-dimensional space to more precisely align punches with the second set of matrix voids 710b. Recall that in some embodiments, while the die matrix 700 may be in a substantially stationary position relative to the punching apparatus, the die matrix 700 may be adjustable in three-dimensional space to correct for relatively small misalignments (on the order of thousandths of an inch) between punches and corresponding matrix voids 710b.

As will be described herein, the one or more sensing pins may be mechanically coupled at a fixed physical distance or orientation to the punches of the punch apparatus. Accordingly, when the one or more sensing pins are successfully received within the at least one locating aperture 790 of the matrix die, the punches may be oriented and aligned with corresponding matrix voids 710b of the die matrix 700.

FIG. 7 illustrates a first set 710a and a second set 710b of die matrix voids having example dimensions, shapes, and positions on the die matrix 700. Other dimensions, shapes, or positions on the die matrix 700 may be used. Similarly, FIG. 7 illustrates the at least one locating aperture 790 as being substantially circular and positioned proximal to an end portion of the die matrix 700. Other dimensions, shapes, or positions on the die matrix 700 may be used.

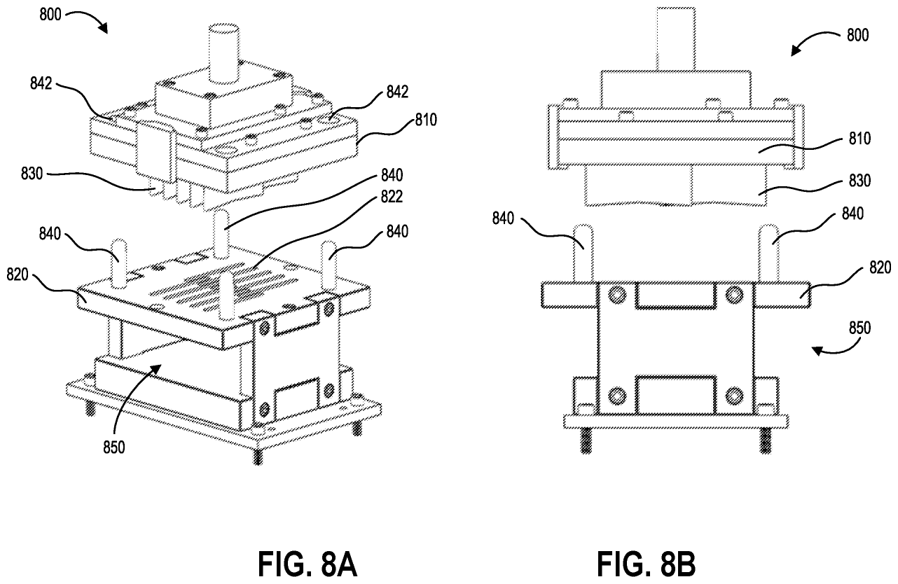

Reference is made to FIGS. 8A and 8B, which illustrates a perspective view and a side view, respectively, of components a punching apparatus 800, in accordance with embodiments of the present disclosure. For example, the panel punching stage 430 (FIG. 4) may include the punching apparatus 800.

The punching apparatus 800 may include an upper die shoe 810 and a corresponding lower die shoe 820. During punching operations, the upper die shoe 810 may be advanced towards or advanced away from the lower die shoe 820.

The punching apparatus 800 may include a plurality of punches 830 coupled to the upper die shoe 810, and the punching apparatus 800 may include a plurality of lower die shoe voids 822 corresponding to the plurality of punches 830. During punching operations, when the upper die shoe 810 is in positional alignment with the lower die shoe 820 and advanced towards the lower die shoe 820, the punches 830 may be thrust towards the lower die shoe voids 822.

Further, when an elongate panel having a die matrix 700 (FIG. 7) received therein is conveyed into a panel receiving chamber 850, the punches 830 may be thrust towards and through: (a) a wall of the elongate panel; and (b) one or more die matrix voids 710b. A combination of: (i) the punches 830 being thrust through the die matrix voids 710b and (ii) the die matrix 700 supporting the wall of the elongate panel may result in punching of slots in the elongate panel wall based on shearing forces.

In some embodiments, the punching apparatus 800 may include one or more alignment posts 840 configured to advance within alignment voids 842. When the upper die shoe 810 is positionally aligned with the lower die shoe 820 for punching slots, the alignment posts 840 may be received within the alignment voids 842.

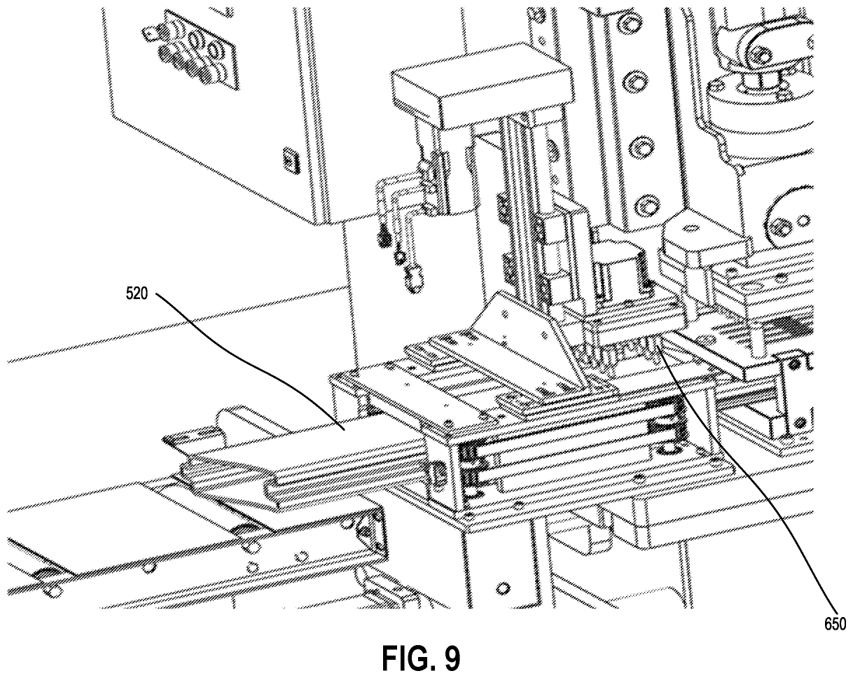

Reference is made to FIG. 9, which illustrates a enlarged, partial view of the system 400 of FIG. 4. For example, FIG. 9 illustrates an enlarged, front perspective view of the panel routing stage 420 and components of the panel punching stage 430. The hollow elongate panel 520 (FIG. 5) may be conveyed or advanced to the panel routing stage 420. For example, the hollow elongate panel 520 may include a first panel portion, and the panel routing stage 420 may include operations for advancing router bits 650 (FIG. 6) towards the hollow elongate panel 520. As described in examples herein, the one or more router bits 650 may route an initial set of slots. Such initial set of slots may function as clearance slots for downstream operations to detect positional alignment of: (a) punches of a punching apparatus relative to (b) a die matrix positioned within the hollow elongate panel being conveyed through the system 400 (FIG. 4).

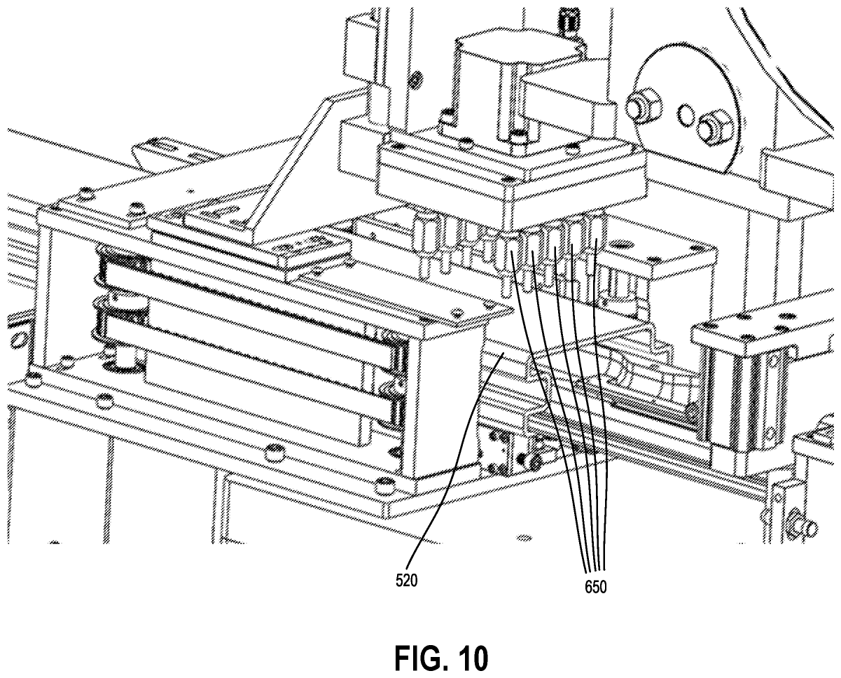

Reference is made to FIG. 10, which illustrates a partial, rear perspective view of the panel routing stage 420 of FIG. 4. In FIG. 10, the plurality of router bits 650 are illustrated while in an elevated position as the hollow elongate panel 520 is being conveyed towards the panel routing stage 420.

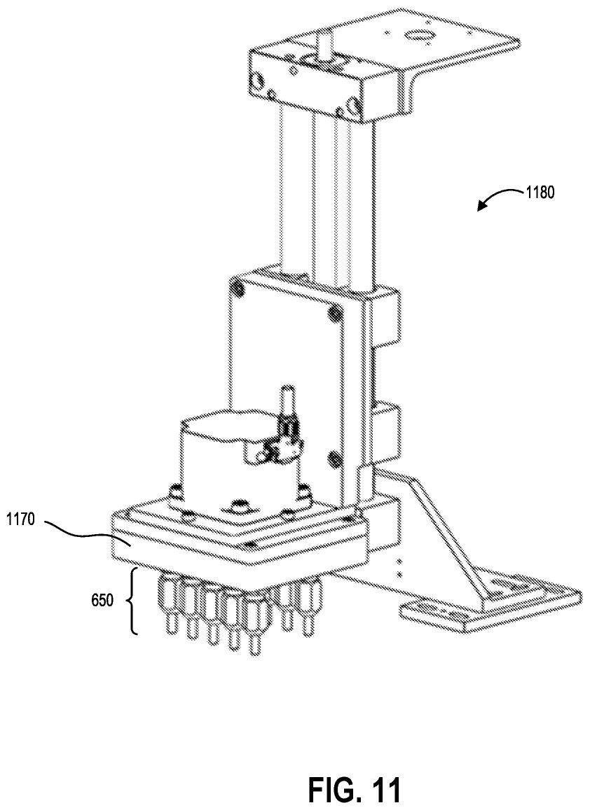

Reference is made to FIG. 11, which illustrates a partial, perspective view of a routing apparatus 1100 of the panel routing stage 420 (FIG. 4), in accordance with embodiments of the present disclosure. The routing apparatus 1100 includes one or more router bits 650 that may be advanced towards an elongate hollow panel to route slots therein.

The one or more router bits 650 may be mounted on a routing base 1170. In FIG. 11, the routing base 1170 may be coupled to ten router bits 650 to provide a ten-spindle router head. It may be understood that any number of router bits 650 may be used.

The routing base 1170 may be configured to position the one or more router bits 650 such that a plurality of slots may be routed in a specified configuration. As an example with reference to FIG. 3A, the routing base 1170 may position the one or more router bits 650 such that one or more slots 360 may be routed in a wall of an elongate panel over time as the elongate panel is conveyed through the panel routing stage 420. In some embodiments, the hollow elongate panel may be conveyed or advanced by a belt driven device.

In some embodiments, the routing base 1170 may be coupled to an adjustable mounting apparatus 1180 for advancing the one or more router bits 650 towards or away from an elongate panel being conveyed through the panel routing stage 420. In some embodiments, the adjustable mounting apparatus 1180 may be pneumatically driven. In some embodiments, the adjustable mounting apparatus 1180 may be driven by servo motors or other types of motors. Other methods of moving the adjustable mounting apparatus 1180 may be used.

In FIG. 11, the adjustable mounting apparatus 1180 may include a column on which the routing base 1170 may be adjustably advanced towards or away from an elongate panel conveyed beneath the one or more router bits 650.

In some embodiments, at least a portion of the die matrix 700 (FIG. 7) may be in a substantially stationary position relative to the one or more router bits 650. For example, the first set of die matrix voids 710a (FIG. 7) may be adjacent the one or more router bits 650, such that the one or more router bits 650 may be advanced towards the hollow elongate panel for cutting slots in the hollow elongate panel wall.

The first set of die matrix voids 710a may be sized or positioned to allow the one or more router bits 650 to descend into the respective die matrix voids 710a without touching edges of the respective die matrix voids 710a. Thus, the die matrix 710 may provide support to the hollow elongate panel wall whilst the one or more router bits 650 route the first set of slots in the hollow elongate panel.

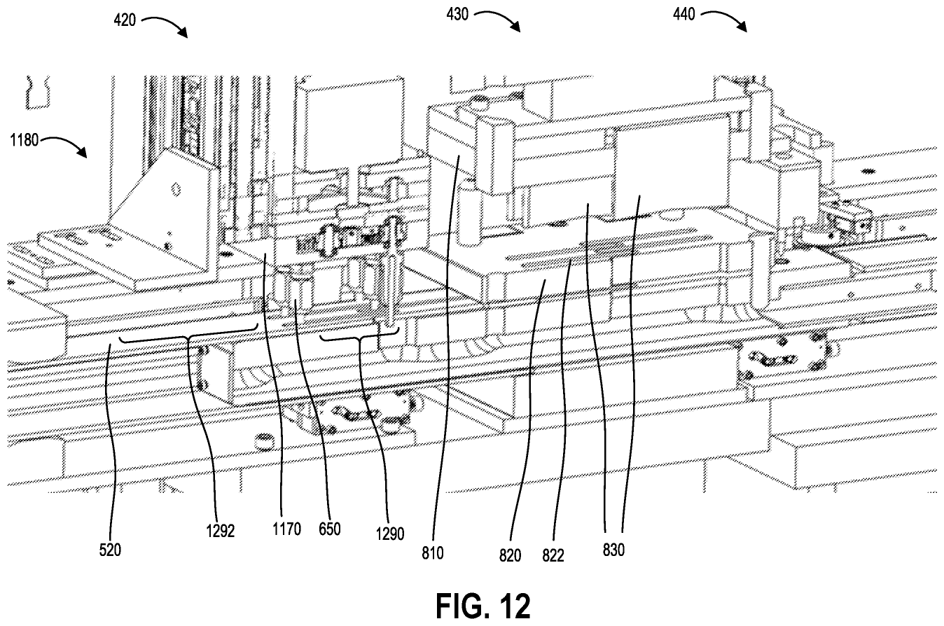

Reference is made to FIG. 12, which illustrates an enlarged cross-sectional view of the panel routing stage 420, the panel punching stage 430, and the alignment sensing stage 440 of the system 400 of FIG. 4. In FIG. 12, the adjustable mounting apparatus 1180 is shown to be advancing the routing base 1170 towards the elongate panel 520 such that the plurality of router bits 650 may route an initial set of slots at a wall of the elongate panel 520 as the elongate panel 520 is conveyed through the panel routing stage 420.

In some embodiments, the first portion of the elongate panel 520 may be at an upstream end of the elongate panel 520. For ease of exposition, in FIG. 12, the first portion of the elongate panel 520 may be generally identified with reference numeral 1290.

The panel punching stage 430 may conduct operations for cutting (e.g., punching operations) slots in the elongate panel 520 at downstream or subsequent portions of the elongate panel 520. For ease of exposition, in FIG. 12, the downstream portions of the elongate panel 520 may be generally identified with reference numeral 1292. The downstream portions 1292 may be subsequent portions of panel wall along the elongate panel 520.

Once the initial set of slots at the first portion 1290 have been routed, the system 400 may convey the elongate panel 520 towards the alignment sensing stage 440. In some embodiments, the system 400 may convey the first portion 1290 of the elongate panel 520 beyond the panel punching stage 430. The system 400 may be configured to bypass punching operations at the first portion 1290, at least, because slots would have already been manufactured at the panel routing stage 420. The system 400 may convey the first portion 1290 towards the alignment sensing stage 440. In some embodiments, a conveyor belt device may convey the first portion 1290 towards the alignment sensing stage 440.

Prior to operations for punching slots at downstream portions 1292 of the elongate panel 520, the alignment sensing stage 440 may include operations for confirming positional alignment of die matrix voids (e.g., second set of die matrix voids 710b) with the plurality of punches 830 (e.g., panel punching stage 430). That is, operations of the alignment sensing stage 440 may confirm positional alignment of the die matrix 700/second set of die matrix voids 710b with the punches 830.

In scenarios where the punches 830 and the die matrix voids 710b may be misaligned, advancing the punches 830 towards the die matrix 700 positioned within the elongate panel 520 may result in punches 830 being thrust, at least partly, on a solid portion of the die matrix 700 and damaging at least the punches 830 or the die matrix 700. In some scenarios, misalignment of punches 830 relative to the die matrix voids 710b by more than a few thousandths of an inch may cause damaging results.

In some scenarios, the die matrix voids 710b may become misaligned with the punches 830 when the hollow elongate panel may be introduced to and slid over the die matrix 700 at the panel receipt stage 410. Small positional or orientation movements of the die matrix 700 relative to punches 830 may subsequently cause the die matrix voids 710b to be misaligned from punches 830 at the panel punching stage 430. Accordingly, in scenarios where the punches 830 and the die matrix voids 710b may be misaligned, the system 400 may conduct operations to restrain punching operations at the panel punching stage 430 for reducing likelihood of operations that may damage the system 400.

The alignment sensing stage 440 may include operations for advancing at least one sensing pin towards prior-routed clearance slots and into the at least one locating aperture 790 (FIG. 7). The one or more sensing pins may be mechanically coupled to the punches of the panel punching stage by a fixed physical distance or orientation. Accordingly, by aligning at least one of the locating apertures 790 with the at least one sensing pin, the system 400 may correspondingly align the die matrix 700 such that the second set of die matrix voids 710b are aligned with corresponding punches 830 at the panel punching stage 430.

As will be described in the present disclosure, the alignment sensing stage 440 may include operations for detecting when the sensing pin is received by the at least one locating aperture 790 and, in response, transmit a signal to the punching apparatus for advancing one or more punches towards the hollow elongate panel and through at least one matrix void 710b of the die matrix 700.

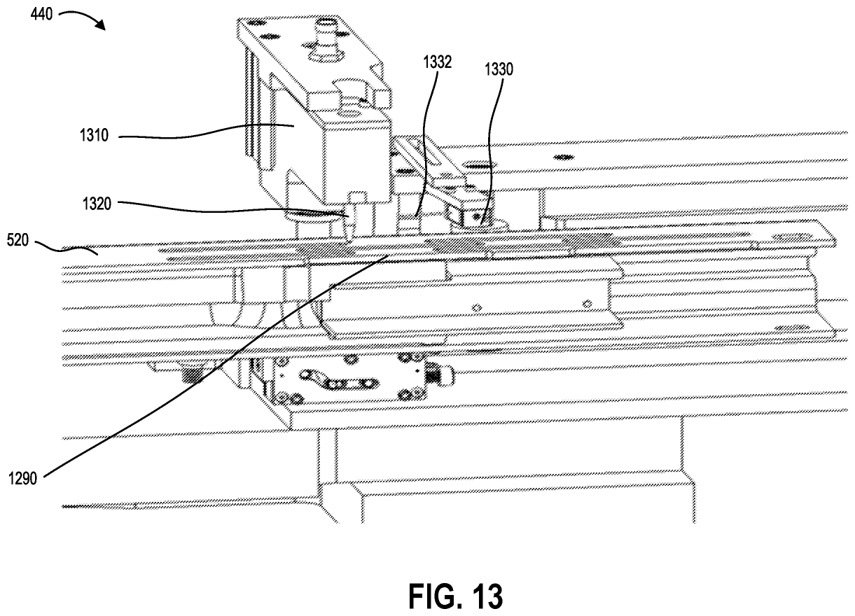

Reference is made to FIG. 13, which illustrates an enlarged, cross-sectional view of the alignment sensing stage 440 of the system 400 of FIG. 4, in accordance with embodiments of the present disclosure. The alignment sensing stage 440 may include a sensing base 1310 and at least one sensing pin 1320 mounted to the sensing base 1310. The at least one sensing pin 1320 may be configured to advance through a clearance slot (e.g., a prior-routed slot from the panel routing stage 420 (FIG. 4)) and for receipt by at least one locating aperture 790 of the die matrix.

In some embodiments, the one or more sensing pins 1320 may be configured to advance into clearance slots of the elongate panel 520 and into one or more locating apertures 790. When the one or more sensing pins 1320 are successfully inserted into one or more locating apertures 790, the sensing pins 1320 may validate positional alignment of the punches 830 (FIG. 8) with matrix voids 710b (FIG. 7). In scenarios where the sensing pins 1320 are received within corresponding locating apertures 790, the system may determine that the die matrix 700 is positioned as expected for punching operations.

In scenarios where the sensing pins 1320 may not be received within corresponding locating apertures 790 despite being lowered towards the clearance slots of the hollow elongate panel, the system may determine that the die matrix 700 is positionally misaligned beyond a threshold tolerance amount. The system may transmit a signal to the panel punching stage 430 to halt punching operations.

In scenarios where the sensing pins 1320 may not be substantially aligned with corresponding locating apertures 790, but may be within a threshold tolerance distance of the corresponding locating apertures 790, the sensing pins 1320 may be lowered through the clearance slots, thereby causing small positional movements of the die matrix 700 and resulting in substantial alignment of the die matrix voids 710b with the punches 830 of the panel punching stage 430.

In some embodiments, the sensing pins 1320 may include a distal end having a reduced dimension, such as a tapered distal end, to assist the one or more sensing pins 1320 to engage with the corresponding locating apertures 790 and to provide positional adjustments of the die matrix 700 relative to the punching apparatus features of the panel punching stage 430. Further, when the sensing pins 1320 engage with the corresponding locating apertures 790, the sensing pins 1320 provide a “fail-safe” check to confirm that the punches are positionally aligned with corresponding matrix voids of the die matrix.

In the example of the sensing pins 1320 including a distal end having a reduced dimension, such as a tapered distal end, the sensing pins 1320 may be more easily extended to and received within a corresponding locating aperture, even when the sensing pins 1320 may not be precisely aligned with the corresponding locating aperture.

In an example where the sensing pins 1320 may not have a distal end having a reduce dimension, when the sensing pins 1320 may not be aligned with the corresponding locating aperture, the sensing pins 1320 may collide with a non-void portion of the die matrix. In such an example, the sensing pins 1320 or the die matrix may be damaged.

In some embodiments, the alignment sensing stage 440 may include a sensing device 1330. In some embodiments, the sensing device 1330 may be an optical sensing device positioned downstream from the locating pin 1320. For example, the sensing device 1330 may be a laser-based sensor, an infrared-based sensor, an inductive proximity sensor/switch, or image sensor (e.g., charge coupled device sensor or the like). Other types of sensing devices for detecting position of the one or more sensing pins may be used.

The sensing device 1330 may be configured to monitor movement of the sensing pin 1320. In an example where the sensing device 1330 may be a laser-based or infrared-based sensor, the sensing device 1330 may emit an optical beam towards the locating pin 1320 and detecting interaction of the optical beam with the locating pin 1320 (e.g., reflection, etc.).

In scenarios where the sensing pin 1320 may be positionally aligned with a corresponding locating aperture 790 in the die matrix 700, the alignment sensing apparatus may track or detect that the sensing pin 1320 has been received within the corresponding locating aperture 790, thereby validating positional alignment of the punches 830 with matrix voids 710b at the panel punching stage 430.

In scenarios where the sensing pin 1320 may not be advanced through the clearance slots (e.g., prior routed slots) or may not be received within a corresponding locating aperture 790, the alignment sensing apparatus may transmit a signal to the punching apparatus indicating that the punches 830 may be misaligned from the matrix voids 710b by a distance greater than a threshold value. In an example where the locating aperture 790 may be a circular aperture, the threshold value may be a radius dimension of the locating aperture 790.

Continuing with the above example, when the one or more sensing pins 1320 may be lowered to a position to meet a non-void portion of the elongate panel wall, the sensing device 1330 may identify that the sensing pin 1320 has not been advanced through the corresponding locating aperture 790. The transmitted signal may be an indicator signal for temporarily halting punching operations, so as to reduce occurrences of self-destructing operations. In some scenarios, the transmitted signal may halt operations of the overall system until positioning or placement of the die matrix is re-calibrated relative to the punching apparatus (e.g., punching apparatus 800 of FIG. 8) or the sensing apparatus.

In the present example, determining misaligned positioning of the sensing pin 1320 relative to a corresponding locating aperture 790 may be operations for identifying scenarios when the die matrix 700 (and corresponding die matrix voids 710b) physically positioned upstream of the alignment sensing stage 440 may be misaligned with punches 830 at the panel punching stage 430.

In some embodiments, the sensing device 1330 may be a laser sensing device, and the sensing device 1330 may emit a laser beam in the direction of the locating pin 1320 for tracking movement or positioning of the locating pin 1320. Other types of optical sensing devices, such as image sensors, inductive proximity switches, infrared sensors, or the like may be contemplated.

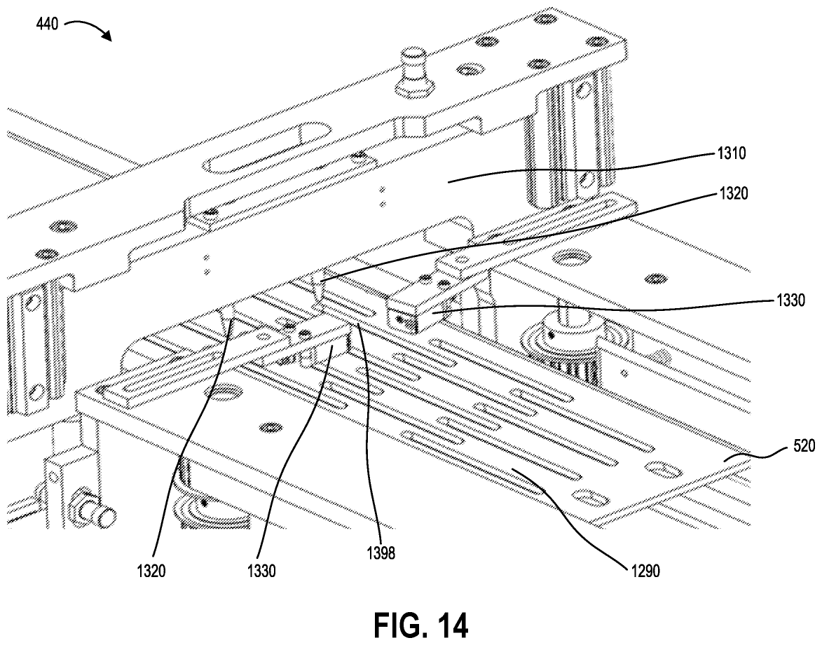

Reference is made to FIG. 14, which illustrates a rear perspective view of the alignment sensing stage 440 illustrated in FIG. 13. In FIG. 14, as the first portion 1290 of the elongate panel 520 advances through the alignment sensing stage 440, the sensing base 1310 may adjustably advance towards or away from the elongate panel 520.

The one or more sensing pins 1320 may be mounted to the sensing base 1310. Further, the sensing base 1310 may be coupled to the punching apparatus by a fixed or known distance or orientation. In the presently describe embodiment, punches 830 may thus be coupled to the one or more sensing pins 1320.

To determine whether the punches 830 may be positionally aligned with matrix voids 710b, the at least one sensing pin 1320 may be advanced through the clearance slots 1398 (e.g., a prior routed slot from the panel routing stage 420) and towards a corresponding locating aperture 790. By monitoring the positioning of the at least one sensing pin 1320, the alignment sensing apparatus of the alignment sensing stage 440 may detect whether the die matrix 700 is positioned for punching operations, and more specifically whether the die matrix voids 710b (FIG. 7) are substantially aligned with punches 830 of the panel punching stage 430.

That is, if the sensing device 1330 detects that the one or more sensing pins 1320 are successfully received within a corresponding locating aperture 790 (in the die matrix), then the alignment sensing stage 440 may generate a signal indicating that the punches 830 are substantially aligned with matrix voids 710b and that the punches may be advanced towards the matrix voids 710b for punching slots in the hollow elongate panel.

In some embodiments, features of the alignment sensing stage 440 may be calibrated such that when the one or more sensing pins 1320 are successfully received within a corresponding locating aperture 790, the punches 830 are substantially aligned with corresponding matrix voids 710b. For example, the punches 830 may be coupled to the sensing pins 1320 via the sensing base 1310 such that when the sensing pins 1320 are successfully received within a corresponding locating aperture 790, the punches 830 are expected to and will be successfully received within corresponding matrix voids 710b.

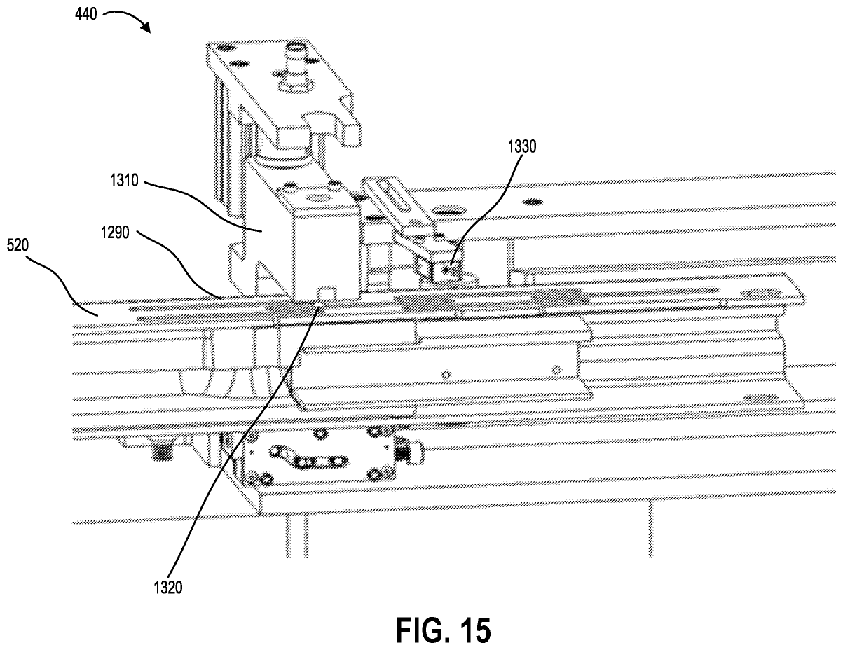

Reference is made to FIG. 15, which illustrates an enlarged, cross-sectional view of the alignment sensing stage 440 of the system of FIG. 4. In FIG. 15, the sensing pin 1320 has been advanced through a prior-routed clearance slot in the hollow elongate panel 520. The sensing pin 1320 is illustrated as being received within a locating aperture (not explicitly shown in FIG. 15) of the die matrix.

The sensing device 1330 may be configured to detect a changing position of the sensing pin 1320 relative to the elongate panel 520. For example, the sensing device 1330 may be configured to monitor movement of the sensing pin 1320, and the alignment sensing apparatus may be configured to identify when the sensing pin 1320 has been lowered into a corresponding locating aperture 790, thereby determining that the die matrix 700 is positioned as required for reducing occurrences of self-destructing punching apparatus operations.

Examples of self-destructing operations may include advancing punches 830 into a non-void or non-aperture portions of the die matrix 700. In the above-described embodiments, determining movement or location of the sensing pin 1320 may generate data for determining whether a die matrix 700 (FIG. 7) is positioned at an expected position for punching operations at the panel punching stage 430.

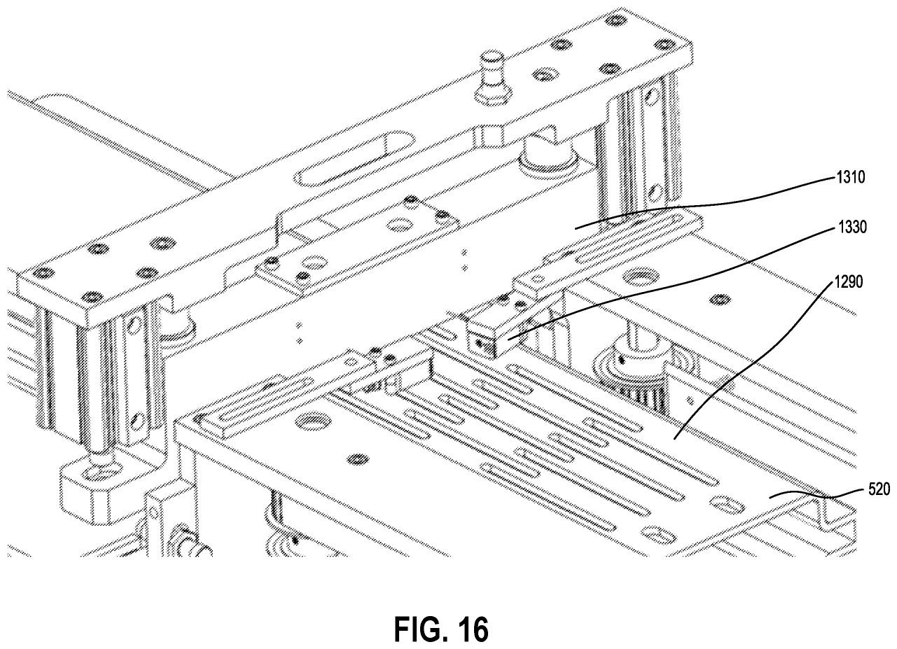

Reference is made to FIG. 16, which illustrates a rear perspective view of the alignment sensing stage 440 illustrated in FIG. 15. In FIG. 16, sensing pin 1320 has been advanced through a clearance slot in the hollow elongate panel 520 and is received within at least one locating aperture of the die matrix.

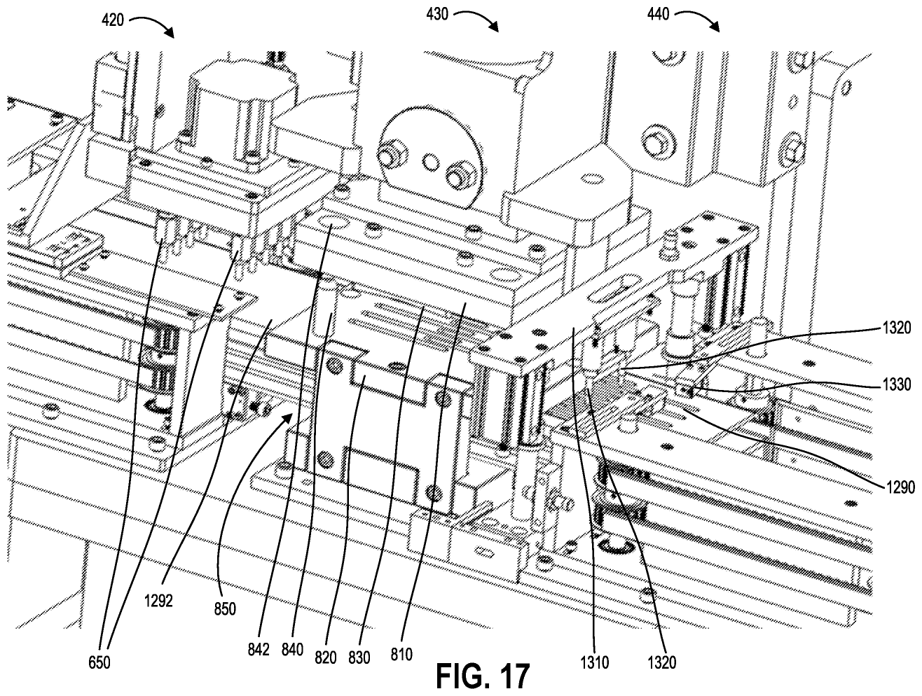

Reference is made to FIG. 17, which illustrates an enlarged, rear perspective view of the panel routing stage 420, the panel punching stage 430, and the alignment sensing stage 440 of the system 400 of FIG. 4. In some embodiments, prior-routed slots (from panel routing stage 420) in the first panel portion 1290 of the hollow elongate panel 520 may be clearance slots through which a sensing pin 1320 may be advanced through (at the alignment sensing stage 440).

The panel routing stage 420 may include a routing apparatus having one or more router bits configured to route at least one slot in the first panel portion 1290 of the hollow elongate panel 520. The first panel portion 1290 may be upstream from the second panel portion 1292 of the elongate panel 520.

Subsequent to operations at the panel routing stage 420, the system 400 may convey the first panel portion 1290 towards the alignment sensing stage 440. When the first panel portion 1290 is proximal to an alignment sensing apparatus, the second panel portion 1292 (downstream from the first panel portion 1290) may be proximal to the panel punching stage 430, and may be positioned within the panel receiving chamber 850. The panel receiving chamber 850 may be associated with a punching apparatus for punching one or more slots in the second panel portion 1292.

The panel punching stage 430 may include the punching apparatus for punching one or more slots in the second panel portion 1292. As router bits 650 associated with the panel routing stage 420 may be consumable components that require periodic replacement, it may be desirable to produce panel slots based on a combination of routing or milling operations (by the router bits 650) and punching operations (by the punches 830). In some scenarios, punches 830 may require relatively less maintenance, and may be configured to produce a greater number of slots for a given quantity of time as compared to producing slots based on solely on milling operations by router bits 650.

At the panel punching stage 430, one or more punches 830 may be advanced towards the die matrix that is received within the hollow elongate panel 520. For example, the punches 830 may be thrust towards the wall of the second panel portion 1292 and through a corresponding matrix void for producing slots in the hollow elongate panel.

Punches 830 that are misaligned with matrix voids by as little as a few thousandths of an inch may result in one or more punches 830 being thrust into a solid portion (e.g., non-void or non-aperture portion) of the die matrix, thereby damaging at least the punches 830 or the die matrix. Accordingly, It may be desirable to configure the system 400 to conduct operations for validating alignment of the punches 830 and corresponding die matrix voids prior to punching panel slots in walls of the elongate panel 520.

As disclosed herein, the alignment sensing stage 440 may include operations for determining whether at least one sensing pin 1320 has been: (i) advanced through a prior-routed clearance slot; and (ii) received within at least one corresponding locating aperture 790 in the die matrix 700 (FIG. 7), prior to commencing punching operations in the panel punching stage 430. Such example operations of the alignment sensing stage 440 may reduce the likelihood that punching operations cause physical damage to the punching apparatus.

In some embodiments, the alignment sensing stage 440 may include one or more sensing devices 1330 configured to track positioning of the sensing pin 1320 relative to the elongate panel 520. The one or more sensing devices 1330 may include optical sensor devices, such as laser-based sensors, infrared-based sensors, among other examples.

In some embodiments, in response to validating at the alignment sensing stage 440 that the one or more sensing pins 1320 are received within corresponding locating apertures 790 in the die matrix, the system 400 may generate and transmit a validation signal to the punching apparatus at the panel punching stage 430 for initiating punching operations. The punching operations may punch one or more slots based on shearing at the wall of the second panel portion 1292 of the elongate panel 520.

In some embodiments, the punching apparatus may include further features to minimize occurrences of misalignment. For example, the punching apparatus may include one or more alignment posts 840 configured to advance within alignment voids 842 when the upper die shoe 810 is thrust towards the lower die shoe 820.

In some embodiments, the lower die shoe 820 may include a plurality of lower die shoe voids 822 corresponding to the plurality of punches 830. During punching operations, when the upper die shoe 810 is in positional alignment with the lower die shoe 820 and advances towards the lower die shoe 820, the punches 830 may be thrust towards the lower die shoe voids 822. In scenarios where the upper die shoe 810 may not be in desired positional alignment with the lower die shoe 820, misalignment of the alignment posts 840 and corresponding alignment voids 842 may prevent the punches 830 from being lowered towards the lower die shoe voids 822.

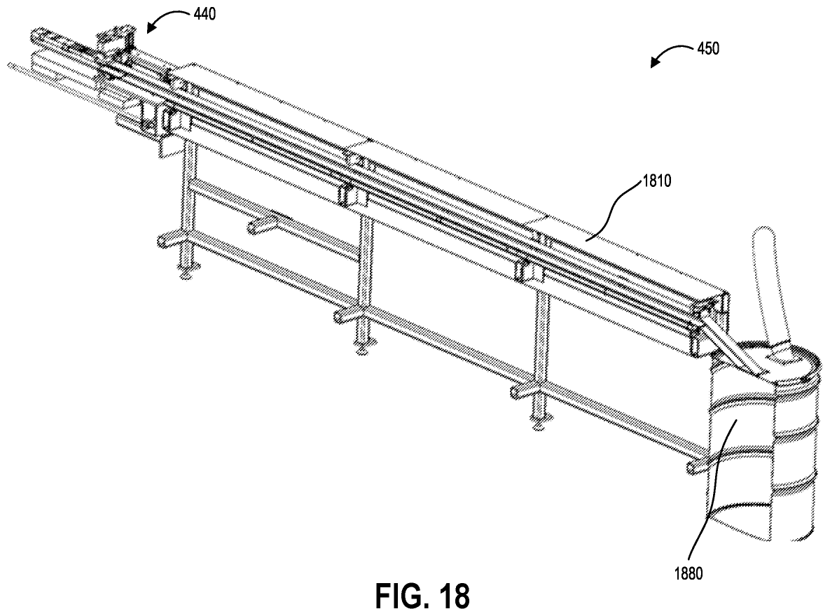

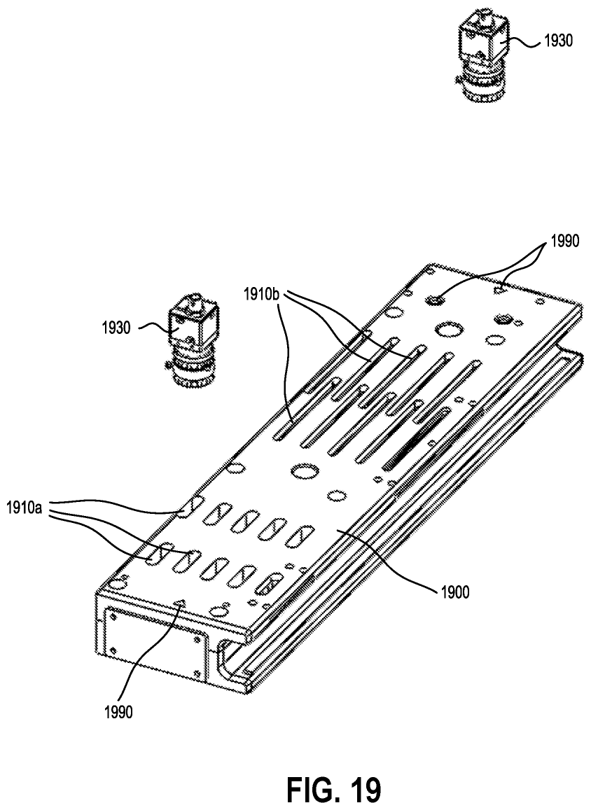

Reference is made to FIG. 18, which illustrates a cross-sectional, perspective view of the cutout evacuation stage 450 of the system 400 in FIG. 4. In some embodiments, the cutout evacuation stage 450 may include a vacuum generating apparatus to generate vacuum suction for collecting elongate panel cutouts or other debris generated at the panel routing stage 420 or the panel punching stage 430. Collected hollow elongate panel cutouts or other debris may be conveyed along a conveyance conduit 1810 based on air flow generated by a vacuum device. The collected elongate panel cutouts or other debris may be collected in a collection chamber 1880.

In some embodiments, when the vacuum generating apparatus is configured to generate vacuum suction, panel cutouts or debris may be drawn away from an inner chamber of the die matrix. That is, during operations at the panel routing stage 420 or operations at the panel punching stage 430, panel cutouts or debris may be pushed into the die matrix 700 (FIG. 7) and conveyed by vacuum suction to the collection chamber 1180.

In the example illustrated in FIG. 18, the cutout evacuation stage 450 is illustrated to include a vacuum generating apparatus positioned subsequent to the alignment sensing stage 440. In some other embodiments, operations for evacuating panel cutouts or debris may be integrated with any one or a combination of the panel routing stage 420, panel punching stage, 430, or the alignment sensing stage 440.

As described herein, embodiments of an alignment sensing stage 440 may include one or more sensing pins 1320 being mechanically coupled to punches 830 of the panel punching stage. In scenarios where die matrix voids 710b are misaligned with corresponding punches 830, operations for extending the one or more sensing pins 1320 towards at least one locating aperture 790 can cause positional adjustment of the die matrix 700. The punches 830 may then align with a corresponding die matrix void 710b.

In the present example, because a die matrix void position relative to a locating aperture position on the die matrix corresponds to the relative positioning between the at least one sensing pin and the at least one punch of the punching apparatus, extending of a sensing pin 1320 towards and receipt within a locating aperture results in positional adjustment of the die matrix 700 relative to the punching apparatus.

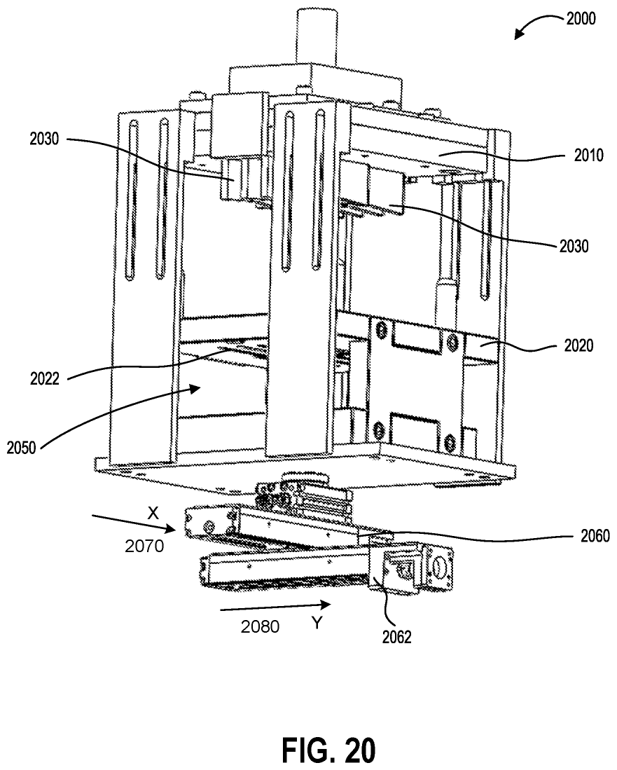

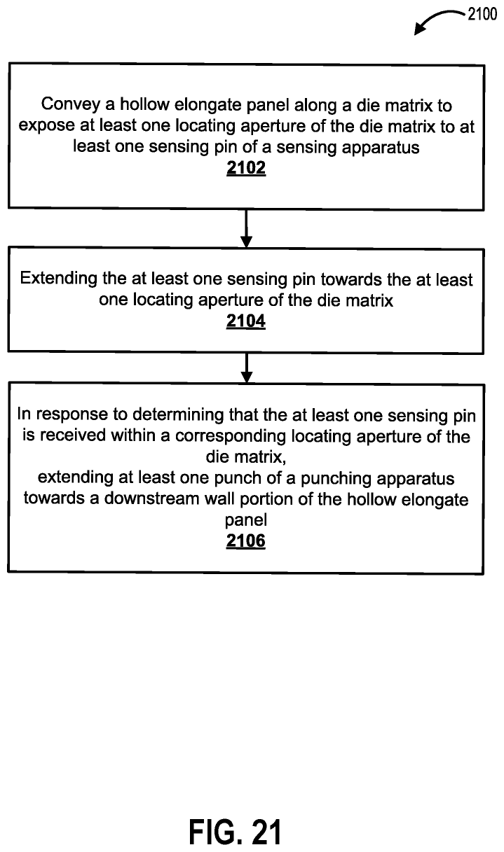

In another embodiment of the present disclosure, a system may include a die matrix having a substantially fixed position relative at least to a panel punching stage and an alignment sensing stage. As will be described with reference to FIGS. 19 and 20, such an alignment sensing stage may include one or more sensing devices for determining, based on fiducial markers or landmarks, whether one or more punches (of the panel punching stage) are substantially aligned with corresponding die matrix voids.

In scenarios where the one or more sensing devices identify that the one or more punches may not be substantially aligned with corresponding die matrix voids (e.g., when operations for punching may result in damage to the punches or the die matrix), the system may be configured to conduct positional adjustment of the punches relative to the die matrix. To illustrate, reference is made to FIG. 19, which illustrates a partial exploded view of an alignment sensing stage, in accordance with embodiments of the present disclosure.

In the example illustrated in FIG. 19, the alignment sensing stage may include one or more sensing devices 1930 for identifying fiducial markers 1990 or other landmark features of the die matrix 1900. The one or more sensing devices 1930 may be configured to obtain one or a series of visual images of a die matrix 1900 for determining whether the die matrix 1900 is positioned relative to punches of a panel punching stage (not explicitly shown in FIG. 19) such that punches are substantially aligned with corresponding die matrix voids 1910b. In the present example, determining whether punches are substantially aligned with corresponding die matrix voids 1910b may be based on image processing operations.

In some embodiments, the one or more sensing devices 1930 may be optical or image capture devices, such as charge-coupled device (CCD) camera devices or other types of image capture devices.

Fiducial markers 1990 or other landmark features may include shapes that aid in determining an orientation or position of the die matrix 1900 relative to apparatus of the panel punching stage or of the alignment sensing stage. In some embodiments, fiducial markers 1990 may include shapes such as triangles or other distinctive shapes for identifying a position or orientation of the die matrix 1900.

In some embodiments, landmark features may include a first set of routing apertures 1910a or other apertures created having known locations or visual properties, such that the alignment sensing stage may conduct operations to infer or determine the position or orientation of the die matrix 1900. In some embodiments, the alignment sensing stage may conduct operations for inferring or determining the position or orientation of the die matrix 1900 in three-dimensional space based on two or more fiducial markers.

In some scenarios, based on images of the die matrix 1900 captured by the sensing devices 1930, the alignment sensing stage may include operations for determining that die matrix voids 1910b are aligned with corresponding punches (not illustrated in FIG. 19) of the panel punching stage. In such scenarios, the alignment sensing stage may transmit a signal to activate punching operations.

In some scenarios, based on images of the die matrix 1900 captured by the sensing devices 1930, the alignment sensing stage may include operations for determining that die matrix voids 1910b are misaligned from corresponding punches of the panel punching stage. In such scenarios, the alignment sensing stage may transmit a signal to positionally adjust a position or orientation of the punches, such that the punches become aligned with corresponding die matrix voids 1910b.

To illustrate features for positionally adjusting features of a punching apparatus, reference is made to FIG. 20, which illustrates a partial perspective view of a punching apparatus 2000, in accordance with embodiments of the present disclosure.

Similar to the punching apparatus 800 illustrated in FIGS. 8A and 8B, the punching apparatus 2000 includes an upper die shoe 2010 and a corresponding lower die shoe 2020. During punching operations, the upper die shoe 2010 may be advanced towards or advanced away from the lower die shoe 2020.

The punching apparatus 2000 includes a plurality of punches 2030 coupled to the upper die shoe 2010, and the punching apparatus 2000 may include a plurality of lower die shoe voids 2022 corresponding to the plurality of punches 2030. During punching operations, when the upper die shoe 2010 is in positional alignment with the lower die shoe 2020 and advanced towards the lower die shoe 2020, the punches 2030 may be thrust towards the lower die shoe voids 2022.

Further, when an elongate panel having the die matrix 1900 (FIG. 19) received therein is conveyed into a panel receiving chamber 2050, the punches 2030 may be thrust towards and through: (a) a wall of the elongate panel; and (b) one or more die matrix voids 1910b (FIG. 19). A combination of (i) the punches 2030 being thrust through the die matrix voids 1910b and (ii) the die matrix 1900 supporting the wall of the elongate panel may result in punching of slots in the elongate panel wall based on shearing forces.

In scenarios where the alignment sensing stage determines that the die matrix voids 1910b are misaligned from corresponding punches 2030 of the punching apparatus 2000, the punching apparatus 2000 may conduct operations to positionally adjust a position or orientation of the punching apparatus 2000 relative to the die matrix 1900. In the present scenario, the position or orientation of the punching apparatus 2000 may be adjusted based on one or more motors coupled to the punching apparatus 2000.

For example, the one or more motors may include a first motor 2060 configured to impart positional adjustments to the punching apparatus 2000 in an X-axis direction 2070. The one or more motors may include a second motor 2062 configured to impart positional adjustments to the punching apparatus 2000 in a Y-axis direction 2080. In some examples, the one or more motors may be servo-motors, stepper motors, or other types of devices for providing positional adjustments. In some embodiments, the punching apparatus 2000 may include one or more additional motors for making rotational or other orientation adjustments to the punching apparatus 2000 relative to the fixed-position the die matrix 1900.

Accordingly, in embodiments including features described with reference to FIG. 19 and FIG. 20, the alignment sensing stage may include image capture devices (e.g., sensing devices 1930) for identifying: (1) position or orientation of the die matrix voids 1910b relative to the punches; and (2) whether the die matrix voids 1910b are aligned with corresponding punches 2030 of the punching apparatus 2000. Determining whether the die matrix voids 1910b are aligned with corresponding punches 2030 may be based on image processing of one or more images obtained showing fiducial markers 1990.

In scenarios where the alignment sensing stage determines that the die matrix voids 1910b are misaligned with corresponding punches 2030, a signal may be transmitted to the one or more motors (e.g., first motor 2060, second motor 2062, or other positioning devices) for adjusting position of the punching apparatus 2000 relative to the die matrix 1900, thereby aligning the position of the die matrix voids 1910b with corresponding punches 2030.

As described herein, the present disclosure describes systems and methods for producing hollow elongate panels.

In an embodiment, a system for punching slots in a hollow elongate panel may include a die matrix configured to be receivable within a hollow elongate panel. For example, the die matrix may be the die matrix 700 illustrated in FIG. 7 having at least one locating aperture 790 (FIG. 7) and at least one matrix void, such as the second set of matrix voids 710b (FIG. 7).

The system may include a punching apparatus including at least one punch. For example, the at least one punch may a plurality of punches 830 illustrated in FIGS. 8A and 8B and configured to extend through corresponding matrix voids of the die matrix to punch one or more slots at the wall of the hollow elongate panel.

In some embodiments, the die matrix 700 may be configured to substantially occupy an interior cavity of the hollow elongate panel to support an inner volume of the hollow elongate panel while the at least one punches 830 extends towards the hollow elongate panel.

The system may include a sensing apparatus including at least one sensing pin configured to be extended towards the at least one locating aperture of the die matrix. For example, as illustrated in FIG. 13, the sensing pins 1320 may be configured to advance towards clearance slots of a hollow elongate panel and into one or more locating apertures 790 of the die matrix. In some embodiments, a clearance slot may be a slot produced in a leading portion of the hollow elongate panel. The clearance slot may be configured to expose the at least one locating aperture 790 of the die matrix when the hollow elongate panel is advanced along the die matrix.

In the present example, the punching apparatus may be configured to punch the one or more slots at a downstream wall portion of the hollow elongate panel in response to the sensing apparatus determining that the at least one sensing pin 1320 is received within a corresponding locating aperture 790 of the die matrix.

In some embodiments, the sensing apparatus may include two or more sensing pins 1320. The die matrix may be positionally adjusted relative to the punching apparatus upon the respective sensing pins being extended within corresponding locating apertures of the die matrix.

In some embodiments, the one or more sensing pins may be mounted to a sensing base 1310 (FIG. 13) or an apparatus frame, and may be positioned relative to at least one punch of the punching apparatus to provide a relative positioning between the at least one sensing pin 1320 and the at least one punch 830 (FIG. 8) of the punching apparatus.

In some embodiments, the one or more sensing pins 1320 may include a distal end having a reduced dimension, such as a tapered distal end. The tapered distal end may be configured to more easily extend to and be received by a locating aperture of the die matrix. The distal tapered end may be desirable in scenarios where the sensing pins 1320 may not be precisely aligned with a corresponding locating aperture.

In some embodiments, the sensing apparatus may include one or more sensor devices configured to identify or determine when at least one of the sensing pins 1320 is received within a corresponding locating aperture 790 of the die matrix.

When the one or more sensing pins 1320 are successfully received within a corresponding locating aperture 790 of the die matrix, the die matrix 700 may be positioned to provide alignment of the die matrix voids 710b with the punches 830. The sensing apparatus may be configured to transmit a punch command to the punching apparatus to extend the punches 830 towards the hollow elongate panel and through the die matrix voids 710b for punching slots.

The system may include a routing apparatus including a router bit, such as router bits 650 (see e.g., FIG. 10). The router bit may be configured to route one or more clearance slots in a leading portion of the hollow elongate panel. The routed clearance slots may be configured to expose the at least one locating aperture 790 of the die matrix when the hollow elongate panel is advanced along the die matrix and towards the alignment sensing stage 440 described herein.

The router bits 650 may be extended towards the die matrix for routing the one or more clearance slots. In particular, the router bits 650 may be extended towards the first set of die matrix voids 710a (FIG. 7), where the first set of die matrix voids 710a may be sized to allow passage of the router bit during the routing of the clearance slot in the hollow elongate panel. Because router bits may be consumable components that require periodic replacement, embodiments of the present disclosure may configure the router bits 650 for routing clearance slots predominantly for the leading portion of the hollow elongate panel. The remainder of slots are produced in the hollow elongate panel by punches of the punching apparatus.

In some embodiments, dimensions of the clearance slots may be substantially similar to the dimensions of the punched slots in the hollow elongate panel. The routed clearance slots in the leading portion of the hollow elongate panel may be for initially exposing the locating apertures 790 to the one or more sensing pins 1320. Subsequently, as the hollow elongate panel is conveyed along the die matrix and through the system, punched slots may function as subsequent clearance slots through which the at least one sensing pins 1320 may be extended through as the hollow elongate panel is further conveyed through the system.

In some embodiments, the routing apparatus includes a computer numeric controlled routing device for routing the clearance slots in the leading portion of the hollow elongate panel.

In some embodiments, the system includes a vacuum apparatus to generate vacuum suction for excavating at least one of the pane slogs or debris from the punching apparatus or the routing apparatus.

Reference is made to FIG. 21, which illustrates a flowchart of a method 2100 of punching slots in a hollow elongate panel, in accordance with embodiments of the present disclosure. The method 2100 may be conducted embodiments of systems described in the present disclosure.

At operation 2102, the system may convey a hollow elongate panel to advance along a die matrix. The die matrix may be geometrically configured to be received within the hollow elongate panel. FIG. 7 illustrates a die matrix including at least one locating aperture 790 and at least one die matrix void (e.g., second set of die matrix voids 710b). The die matrix may be geometrically sized to support an inner volume of the hollow elongate panel for operations of a punching apparatus.

In some embodiments, the system may be configured to produce clearance slots in a leading portion of the hollow elongate panel. For example, the system may route clearance slots in a leading portion of the hollow elongate panel. The clearance slots may be configured to expose the at least one locating aperture 790 of the die matrix when the hollow elongate panel is advanced along the die matrix 700.

The system may convey the hollow elongate panel along the die matrix such that the clearance slot is proximal a sensing pin 1320 (FIG. 13) of a sensing apparatus. The at least one locating aperture 790 may be exposed via the prior-routed or prior manufactured clearance slot to one or more sensing pins 1320.

The present example is based on routing an initial set of clearance slots at a leading portion of the hollow elongate panel for exposing, via the initial set of clearance slots, at least one locating aperture 790 of the die matrix to at least one corresponding sensing pin 1320 of the sensing apparatus. Other methods of producing or introducing the initial set of clearance slots may be used.

At operation 2104, the system may extend the one or more sensing pins 1320 towards the at least one locating aperture 790 of the die matrix 700 (FIG. 7)

In some embodiments, the sensing apparatus may include at least two sensing pins 1320. As described herein, in scenarios where the die matrix 700 may be suspended proximal to the punching apparatus, the sensing apparatus, and other stages of the system, the die matrix 700 may be configured to be positionally adjusted in an X-axis direction 770 (FIG. 7) and a Y-axis direction 780 (FIG. 7). Thus, the sensing apparatus may require two or more sensing pins 1320 are desirable to cause positional adjustments of the die matrix 700 in the two-dimensional plane defined by the X-axis direction 770 and the Y-axis direction.

In some embodiments, the sensing pins 1320 may include a distal end having a reduced dimension configured to extend within the at least one locating aperture 790 for aligning the at least one punch 830 with the at least one die matrix void 710b in the die matrix 700. The reduced dimension may be provided as a tapered distal end.

In some scenarios, sensing pins 1320 having a tapered distal end may be more easily extended to and received within a corresponding locating aperture 790, and even when the sensing pins 1320 may not be precisely aligned with the corresponding locating aperture.

In response to determining that the at least one sensing pin 1320 is received within a corresponding locating aperture 790 of the die matrix, at operation 2106, the system may extend at least one punch 830 of the punching apparatus towards a downstream elongate panel portion of the hollow elongate panel and through corresponding matrix die voids 710b of the matrix die 700 to punch slots in the hollow elongate panel.

In some embodiments, in response to determining that the at least one sensing pin 1320 is received within a corresponding locating aperture 790, the sensing apparatus may transmit a signal representing a punch command to the punching apparatus for advancing the punches 830 towards the downstream wall portion of the hollow elongate panel.

In some embodiments, the punched slots may be subsequent clearance slots through which the at least one sensing pin 1320 is extended through as the hollow panel is further conveyed along the die matrix.

Referring again to FIG. 7, in some embodiments, a maximum diameter of the locating aperture 790 (if the locating aperture 790 is circular) may need to correspond to a height of an elongate slot or to a height of the matrix die voids 710b for ensuring that the punched slots may be suitable subsequent clearance slots through which one or more sensing pins 1320 may be extended through.

In some embodiments, the system may be configured to generate a vacuum suction for excavating at least one of panel slugs or debris from the punching apparatus or the routing apparatus. That is, panel slugs from punching operations or debris from routing operations may be excavated to reduce interference with subsequent or ongoing system operations.

As disclosed based on embodiments described herein, a die matrix void 710b position relative to a locating aperture 790 position on the die matrix 700 may correspond to relative positioning between at least one sensing pin 1320 and at least one punch 830 of the punching apparatus. Accordingly, as an illustrating example, two or more sensing pins 1320 successfully received within corresponding locating apertures 790 of the die matrix 700 may cause positional adjustments of the die matrix 700 in two-dimensional plane (e.g., X-axis direction and/or Y-axis direction) and thereby causing the matrix voids 710b of the die matrix 700 to be oriented and aligned (e.g., if not yet already aligned) with punches 830 of the punching apparatus.

Based on one or more embodiments described herein, systems and methods having features for producing slots in hollow elongate structures to reduce occurrences of self-destructing operations are disclosed.

The term “connected” or “coupled to” may include both direct coupling (in which two elements that are coupled to each other contact each other) and indirect coupling (in which at least one additional element is located between the two elements).

Although the embodiments have been described in detail, it should be understood that various changes, substitutions and alterations can be made herein without departing from the scope. Moreover, the scope of the present disclosure is not intended to be limited to the particular embodiments of the process, machine, manufacture, composition of matter, means, methods and steps described in the specification.

As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized. Accordingly, the appended claims are intended to include within their scope such processes, machines, manufacture, compositions of matter, means, methods, or steps.

The description provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As can be understood, the examples described above and illustrated are intended to be exemplary only.

What is claimed is:

1. A method of punching slots in a hollow elongate panel comprising:
conveying the hollow elongate panel along a die matrix to expose, via a clearance slot, at least one locating aperture of the die matrix to at least one sensing pin of a sensing apparatus, the die matrix received within the hollow elongate panel, the die matrix including at least one die matrix void and the at least one locating aperture;
extending the at least one sensing pin towards the at least one locating aperture of the die matrix; and
in response to determining that the at least one sensing pin is received within a corresponding locating aperture of the die matrix, extending at least one punch of a punching apparatus towards a downstream wall portion of the hollow elongate panel and through corresponding matrix voids of the die matrix to punch slots in the hollow elongate panel.

2. The method of claim 1, wherein the sensing apparatus includes at least two sensing pins, and wherein the die matrix is positionally adjusted relative to the punching apparatus upon the respective sensing pins being extended within corresponding locating apertures of the die matrix.

3. The method of claim 1, wherein a die matrix void position relative to a locating aperture position on the die matrix corresponds to the relative positioning between the at least one sensing pin and the at least one punch of the punching apparatus.

4. The method of claim 3, wherein the sensing pin includes a distal end having a reduced dimension configured to extend within the at least one locating aperture for aligning the at least one punch with the at least one die matrix void in the die matrix.

5. The method of claim 1, comprising: routing the clearance slot in a leading portion of the hollow elongate panel, the clearance slot configured to expose the at least one locating aperture of the die matrix when the hollow elongate panel is advanced along the die matrix.

6. The method of claim 5, wherein the punched slots are subsequent clearance slots through which the at least one sensing pin is extended through as the hollow elongate panel is further conveyed along the die matrix.

7. The method of claim 1, wherein the die matrix is geometrically sized to support an inner volume of the hollow elongate panel for the punching apparatus.

8. The method of claim 1, wherein in response to determining that the sensing pin is received within the locating aperture, the method comprises transmitting a signal representing a punch command to the punching apparatus for advancing the punches towards the downstream wall portion.

9. The method of claim 1, comprising: generating vacuum suction for excavating at least one of panel slugs or debris from the punching apparatus or the routing apparatus.

10. A system for punching slots in a hollow elongate panel comprising:
a die matrix configured to be receivable within the hollow elongate panel, the die matrix including at least one locating aperture and at least one matrix void;
a punching apparatus including at least one punch configured to be extended through corresponding matrix voids of the die matrix to punch one or more slots at the wall of the hollow panel; and
a sensing apparatus including at least one sensing pin configured to be extended towards the at least one locating aperture of the die matrix,
wherein the punching apparatus is configured to punch the one or more slots at a downstream wall portion the hollow elongate panel in response to the sensing apparatus determining that the at least one sensing pin is received within a corresponding locating aperture of the die matrix.

11. The system of claim 10, wherein the sensing apparatus includes at least two sensing pins, and wherein the die matrix is positionally adjusted relative to the punching apparatus upon the respective sensing pins being extended within corresponding locating apertures of the die matrix.

12. The system of claim 10, wherein the at least one sensing pin is mounted to an apparatus frame and is positioned relative to the at least one punch of the punching apparatus to provide relative positioning between the at least one sensing pin and the at least one punch of the punching apparatus.

13. The system of claim 12, wherein a die matrix void position relative to a locating aperture position on the die matrix corresponds to the relative positioning between the at least one sensing pin and the at least one punch of the punching apparatus.

14. The system of claim 13, wherein the sensing pin includes a distal end having a reduced dimension configured to be extended within the at least one locating aperture for aligning the at least one punch with the at least one die matrix void in the die matrix.

15. The system of claim 10, comprising a routing apparatus including a router bit configured to route a clearance slot in a leading portion of the hollow elongate panel, the clearance slot configured to expose the at least one locating aperture of the die matrix when the hollow elongate panel is advanced along the die matrix.

16. The system of claim 15, wherein the punched slots are subsequent clearance slots through which the at least one sensing pin is advanced through as the hollow elongate panel is further conveyed along the die matrix.

17. The system of claim 15, wherein the die matrix includes at least one routing aperture configured to allow passage of the router bit during routing of the clearance slot in the hollow panel.

18. The system of claim 10, wherein the die matrix is suspended proximal to the punching apparatus and the alignment sensing apparatus, and wherein the die matrix is receivable within the hollow elongate panel being conveyed through the system.

19. The system of claim 10, wherein the die matrix is configured to substantially occupy an interior cavity of the hollow elongate panel to support an inner volume of the hollow elongate panel while the at least one punch is extended towards the hollow elongate panel.

20. The system of claim 10, wherein the sensing apparatus includes a sensor device configured to determine when at least one sensing pin is received within the at least one locating aperture of the die matrix.

21. The system of claim 20, wherein the sensing apparatus transmits a punch command to the punching apparatus when the at least one sensing pin is received within the at least one locating aperture of the die matrix.

22. The system of claim 20, wherein the sensor device is an optical sensor including at least one of a laser-based sensor or an infrared-based sensor.

23. The system of claim 10, comprising: a conveyance apparatus including a conveying belt configured to advance the hollow panel around the die matrix and convey the hollow panel adjacent to the respective punching apparatus and the alignment sensing apparatus.

24. The system of claim 10, comprising: a vacuum apparatus to generate vacuum suction for excavating at least one of panel slugs or debris from the punching apparatus or the routing apparatus.
